(19) United States
(12) Patent Application Publication
(10) Pub. No.: US 2013/0138458 A1
(43) Pub. Date: May 30, 2013

(54) MOBILE PLATFORM FOR PERSONAL HEALTH RECORDS

(71) Applicant: MyMedicalRecords, Inc., Los Angeles, CA (US)

(72) Inventor: Robert H. Lorsch, Los Angeles, CA (US)

(73) Assignee: MYMEDICALRECORDS, INC., Los Angeles, CA (US)

(21) Appl. No.: 13/748,140

(22) Filed: Jan. 23, 2013

Related U.S. Application Data
(60) Provisional application No. 61/589,805, filed on Jan. 23, 2012.
(60) Provisional application No. 61/600,861, filed on Feb. 20, 2012.

(51) Int. Cl. G06F 19/00

(52) U.S. Cl. CPC G06F 19/322
USPC 705/3

(57) ABSTRACT

A method for managing health records on a mobile device. The method includes providing a mobile application stored on a machine readable storage medium on the mobile device and executing the mobile application on the mobile device to provide for (a) accessing health records using the mobile device, (b) receiving health records at the device, and (c) creating health records using the device.

### PRIORITY STATEMENT

The present application claims priority to U.S. Provisional Patent Application No. 61/589,805 filed Jan. 23, 2012 and U.S. Provisional Patent Application No. 61/600,861 filed Feb. 20, 2012, both of which are herein incorporated by reference in their entireties.

### FIELD OF THE INVENTION

The present invention relates to personal health records. More particularly, but not exclusively, the present invention relates to mobile platforms for personal health records.

### BACKGROUND OF THE INVENTION

What is needed is a mobile platform for personal health records suitable for use on a cell phone or other mobile device.

### BRIEF SUMMARY OF THE INVENTION

Therefore it is a primary object, feature, or advantage of the present invention to improve upon the state of the art.

It is a further object, feature, or advantage of the present invention to facilitate health care personnel's compliance with HIPAA or other legal requirements regarding privacy of medical records.

A still further object, feature, or advantage of the present invention is to provide an individual with meaningful access to their healthcare records thereby allowing the individual to exercise their legal rights with respect to controlling access to their medical records.

Yet another object, feature, or advantage of the present invention is providing individuals with immediate access to healthcare records in emergency situations to assist in providing appropriate care.

A further object, feature, or advantage of the present invention is to provide a convenient and cost effective method for healthcare providers to comply with laws regarding privacy of healthcare records.

A still further object, feature, or advantage of the present invention is to provide a convenient and cost effective method for individuals to request that their healthcare providers provide copies of medical records.

Another object, feature, or advantage of the present invention is to provide a private communications link between healthcare personnel and their patients.

Yet another object, feature, or advantage of the present invention is to provide for placing an individual in control of their medical records and allowing them to selectively provide access to others.

A still further object, feature, or advantage of the present invention is to facilitate storing all of an individual or family's medical records and related information in a single location so that healthcare personnel can be given complete medical information/history when needed or analysis can be performed on the medical records.

Another object, feature, or advantage of the present invention is to provide a means for individuals to create calendars to remind them of the need to refill prescriptions.

Yet another object, feature, or advantage of the present invention is to provide a means for individuals to create calendars to maintain doctor's appointments including appointments for videoconferences.

A further object, feature, or advantage of the present invention is to provide reminder messages regarding the need to refill prescriptions or remember doctor's appointments.

A still further object, feature, or advantage of the present invention is to provide a method to store, organize, and annotate medical records and also to customize the storage by giving the user the ability to name the folders in which those records are stored.

Another object, feature, or advantage of the present invention is to give users the ability to upload images, such as x-rays or scans.

It is a further object, feature, or advantage of the present invention to upload multiple files at the same time.

Yet another object, feature, or advantage of the present invention is to give users the ability to forward records via fax to a healthcare provider.

Yet another object, feature, or advantage of the present invention is to give users the ability to electronically forward records to a healthcare provider.

A further object, feature, or advantage of the present invention is to give users the ability to see if there are any possible interactions between prescription drugs they are taking.

A further object, feature, or advantage of the present invention is to provide a means for individuals to store and access not only medical records, but other types of health records including dental records, healthcare records associated with pets, and vital documents, including, without limitation, wills, living wills, a power of attorney, and a healthcare power of attorney.

Yet another object, feature, or advantage of the present invention is to allow for the healthcare provider to quickly and easily, yet securely, communicate records associated with an individual to the individual.

It is a further object, feature, or advantage of the present invention to provide a mobile platform for personal health records.

It is a still further object, feature, or advantage of the present invention to provide mobile and tablet apps that allow for access to personal health record and emergency view portals.

It is another object, feature, or advantage of the present invention to use a wireless company's voicemail to connect to a personal health record and emergency view portal.

It is a still further object, feature, or advantage of the present invention to provide a mobile which includes an intuitive, mobile-ready configuration.

It is a still further object, feature, or advantage of the present invention to provide a system which allows a user to use their cell phone number interchangeably with a lifeline number.

It is another object, feature, or advantage of the present invention to provide for receiving health information and other important documents by upload, fax or voice.

It is a still further object, feature, or advantage of the present invention to provide a mobile app to enable the user to utilize their camera-equipped smartphone or tablet to take snapshots of images for seamless upload directly into a personal health record account.

It is a still further object, feature, or advantage of the present invention to read bar codes or QR codes from a phone or tablet that may be used to identify personal health record accounts or for other purposes.

It is a further object, feature, or advantage of the present invention to provide a mobile app with voice signature login capability.

It is a still further object, feature, or advantage of the present invention to provide a mobile app with calendar and RX reminder capabilities.

It is a further object, feature, or advantage of the present invention to provide a mobile app which provides for direct faxing with its own dedicated fax number, or linked to voicemail associated with a cell phone carrier.

Another object, feature, or advantage of the present invention is to provide a “My Insurance” folder which is accessible in case of emergency.

A further object, feature, or advantage of the present invention is a global search feature which allows for searching of the contents of files including encrypted PDF files.

A still further object, feature, or advantage of the present invention is to provide access to a portal where health data is consolidated.

Another object, feature, or advantage of the present invention is to provide a system which includes both a web-accessible patient portal and a mobile app for collecting and accessing health data.

Yet another object, feature, or advantage of the present invention is to provide a means for providing a patient portal which encourages meaningful use by patients.

One or more of these and/or other objects, features, or advantages of the present invention will become apparent from the specification and claims that follow.

According to one aspect of the present invention, a mobile app stored on a computer readable storage medium is provided wherein the mobile app provides access to a personal health records portal.

According to another aspect of the present invention, an emergency mobile app is provided. The emergency mobile app is stored on a machine readable storage medium, wherein the emergency mobile app provides for accessing personal health records through a personal health records portal.

According to another aspect of the present invention, a method for managing health records on a mobile device is provided. The method includes providing a mobile application stored on a machine readable storage medium on the mobile device and executing the mobile application on the mobile device to provide for (a) accessing health records using the mobile device, (b) receiving health records at the device, and (c) creating health records using the device. The accessing the health records using the mobile device may include providing a user interface with folders for organizing the health records. The receiving the health records at the device may further include receiving a fax directed to a phone number of the device and storing the fax as a health record. The receiving the health records at the device may further include receiving a voicemail directed to a phone number of the device and storing the voicemail as a health record. The creating the health records using the device may include creating an image of a document using a camera of the device and storing the image of the document as a health record or creating a video using a camera of the device and storing the video as a health record. The video may be a video chat between a user of the device and a health care provider, a video message accessible using the mobile device in event of emergency through use of an emergency login of the mobile application, or other video. The creating the health records may involve receiving a wireless communication from a health monitoring device and creating a health record from data within the wireless communication. The mobile application may have a first login and an emergency login with a subset of health records made available when the emergency login is used to access the mobile device. The first login may be performed using voice identification.

According to another aspect, a mobile app stored on a machine readable storage medium is provided to perform steps of accessing health records using the mobile device, receiving health records at the mobile device, and creating health records using the mobile device.

According to another aspect, a method for providing meaningful access to health records is provided. The method may include providing a portal for accessing the health records through a web-site using a web-enabled device, providing a mobile application stored on a machine readable storage medium of a mobile device for accessing the health records, and making available the health records to a user logging into the web-site using the web-enabled device or logging into the mobile application of the mobile device. The portal may provide a first set of functions for receiving health records and creating health records and the mobile application may provide a second set of functions for receiving health records and creating health records with a subset of the second set of functions not within the first set of functions. Thus, it is contemplated that different functions may be available using the mobile app then available when using the web portal.

### BRIEF DESCRIPTION OF THE DRAWINGS

FIG. 1 is diagram illustrating one embodiment of a system of the present invention.

FIG. 2 is a pictorial representation of a sticker authorizing transmissions of records to the user account according to one embodiment of the present invention.

FIG. 3A and FIG. 3B illustrate a card with medical record access information according to one embodiment of the present invention.

FIG. 4 is a diagram illustrating one embodiment of a system of the present invention.

FIG. 5A and FIG. 5B are flow diagrams illustrating an enrollment process according to one embodiment of the present invention.

FIG. 6 is a flow diagram for accessing records according to one embodiment of the present invention.

FIG. 7 is a screen display of a web site according to one embodiment of the present invention.

FIG. 8 is another screen display of a web site according to one embodiment of the present invention.

FIG. 9 is a screen display according to one embodiment.

FIG. 10 is a screen display for folder administration according to another embodiment.

FIG. 11 is a screen display for an uploaded file feature according to another embodiment of the present invention.

FIG. 12 is a pictorial representation of a preferred embodiment of a sticker providing instructions for faxing medical records.

FIGS. 13 and 14 are pictorial representations of a preferred embodiment of a wallet card which can be used according to the present invention.

FIG. 15 is diagram illustrating one embodiment of drug interacting reporting and analysis of the present invention.

FIG. 16 illustrates one embodiment of a screen display.

FIG. 17 illustrates one embodiment of a screen display which allows a consumer t set an emergency password.

FIG. 18 illustrates one example of a screen display which allows a consumer to select which folders are to be displayed when the emergency password is used to access information.

FIG. 19 illustrates one embodiment of a screen display for displaying medical history items.

FIG. 20 illustrates one embodiment of a screen display for displaying medical history items and which items will be shown in case of emergency.

FIG. 21 is a screen display associated with a web site with an emergency login button.

FIG. 22 is a screen display which collects basic contact information when an emergency login is made.

FIG. 23 is a screen display showing critical information and records provided in case of emergency.

FIG. 24 is another screen display showing critical information and records provided in case of emergency.

FIG. 25 is a screen display illustrating prescription information which can be accessed.

FIG. 26 is a portion of a screen display allowing a user to provide a photograph of the user.

FIG. 27 illustrates an example of a mobile device communicating voicemail or other types of files to a personal health management system.

FIG. 28 illustrates a screen display for an app executing on a mobile device.

FIG. 29 illustrates a screen display for the app of FIG. 28 where the menu has been selected and menu selection items are shown.

FIG. 30 illustrates a screen display for a mobile app showing examples of records that are available when the emergency view is shown.

FIG. 31 is a block diagram describing one example of a mobile app.

FIG. 32 illustrates one example of a block diagram mobile device with the mobile app.

### DETAILED DESCRIPTION OF THE PREFERRED EMBODIMENT

The present invention provides for a convenient method for individuals to collect, store, and manage their private medical information and to provide private communications between the individual and their healthcare providers. The present invention contemplates that records can come from a variety of different sources. For example, records may come from the health care provider. Where records come from the health care provider, the present invention contemplates that paper records may be collected from the health care provider by having the records faxed. Similarly, electronic records from the health care provider may be directly communicated. The present invention further allows for creating personal health records directly from patient monitoring devices or from telemedicine sessions.

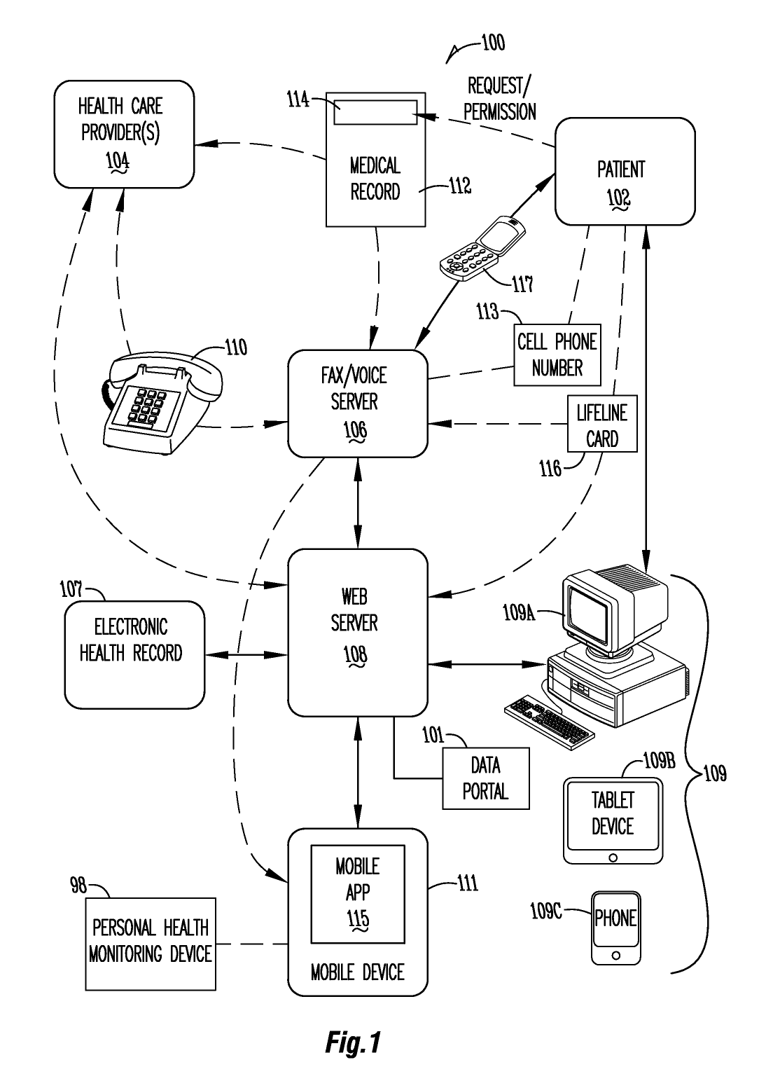

FIG. 1 is a diagram illustrating one embodiment of a system 100 of the present invention. In FIG. 1, a consumer or patient 102 is shown. A healthcare provider 104 is also shown as well as a fax/voice server 106. A web server 108 is operatively connected to the fax/voice server 106. The phone number may be a toll-free number or a DID number. The healthcare provider 104 uses the phone 110 to communicate private voicemail messages through a toll-free dedicated phone number to the fax/voice server 106. In addition, the healthcare provider faxes health or medical records 112 to the fax/voice server 106 using the toll-free dedicated phone number. The medical record 112 (or a folder in which the medical record may be contained) preferably has a sticker 114 present on the medical record 112. The sticker 114 indicates or instructs the healthcare provider 104 or their staff to fax the information to the toll-free dedicated phone number or to otherwise send the information to a destination address. In addition, the sticker 114 provides an indication of clear consent from the patient 102 to the healthcare provider 104 to do so. Thus, it becomes a simple process for a consumer or patient 102 to provide their healthcare provider 104 with instructions to send health records, a simple process for the healthcare provider 104 to obtain permission to fulfill a request for healthcare records, and a simple process for the healthcare provider 104 to do so in a secure and convenient manner.

The web server 108 is operatively connected to the fax/voice server 106 such as over a network or otherwise. A patient 102 or their proxy can communicate directly with the web server 108 through a computing device 109 (which may be, without limitation, a computer 109A, tablet 109B, smart phone 109C, web-enabled device,) or the fax/voice server 106 using a phone 117. The patient 102 can use a LIFELINE card 116 that contains access information to log on to the web server 108 associated with a web site of the present invention, or as a reminder of the phone number which they can call to access voicemail messages, listen to text-to-speech conversion of emails, or otherwise access information.

The present invention also allows a patient 102 to upload files using a computing device 109 to the web server 108. Multiple files may be uploaded at the same time. In addition, the patient 102 can use the computing device 109 to interact with the web server 108 to specify that a prescription or other personal health record is faxed via the fax/voice server 106 to a healthcare provider 104.

In addition, the system allows electronic health records 107 to be communicated to the web server 108. Thus, for example, a health care provider could send electronic health records directly to the system.

As shown in FIG. 1, a cell phone number 113 may be used interchangeably with a number on a lifeline card 116. A mobile device 111 which may be a mobile phone or tablet device or other type of mobile device which has a mobile app 115 executing on it. The mobile device 111 may use any number of types of operating systems such as, but not limited to Android, iOS, Blackberry, Windows Mobile, or other types of operating systems. The mobile device 111 may have a voice mail system or other functionality which may be carrier specific. The mobile app 115 may include a mobile-ready configuration along with icons to access MMR's Emergency View. For example, using Verizon's Visual Voice Mail, a user can use their cell phone number interchangeably with their MyMedicalRecords Lifeline number, making the app a comprehensive emergency health information network for the entire family.

In addition to receiving health information and other important documents by upload, fax or voice, the mobile app may enable the user to utilize their camera-equipped smartphone to take snapshots of images for seamless upload directly into their personal health record user account. The app may also enable the recording of video messages for communication of the patient's health information, prescriptions, contraindications and more in the event of an emergency where the user cannot communicate with emergency personnel. Each user account may also include a plurality of password-protected folders so that users can securely store uploaded receipts, insurance documents, wills, advance directives, financial records, tax returns and copies of other important documents such as a driver's license or passport directly into the application.

The app 115 may also be able to read bar codes and QR codes. This may be used for various purposes. For example, documents may include data embedded in bar codes.

The app 115 may also have a voice signature login capability in addition to a traditional touch screen interface. Also included in the app may be calendar and Rx reminder capability similar to those already in a user account. A “My Insurance” folder may be used speed up the admitting process in an emergency. Other features associated with the portal as described herein may be included within the mobile app 115, including direct faxing with its own dedicated fax number, or linked with the voicemail of a mobile device service provider. It is to be further understood that the web-based portal has a first set of functions and the mobile app 115 may have a second set of functions and that the first set of functions and the second set of functions are not necessarily the same. In other words, the mobile app 115 may include some functions that are specific to the mobile app 115 and not available through the portal while there may be other functions which are specific to the portal and may not be available through the mobile app 115.

The mobile app 115 operating on the mobile device 111 may also provide for connecting with one or more personal health monitoring device 98 and for receiving data from the one or more personal health monitoring devices and placing the data into a health record.

A data portal 101 may also provide data to the web server 108. For example, a service like that available from 4Medica (Culver City, Calif.) may collect and consolidate data from disparate services. This data may include lab results, prescription information, clinical data, or other types of data. The data portal 101 provides an additional means for accessing data.

In addition, it is to be understood that health records may be stored on the mobile device 111 or at one or more services such as the web server 108, or both on the mobile device 111 and on the web server 108 or other servers. It is further to be understood that all or a subset of the health records may be stored on the mobile device. 111.

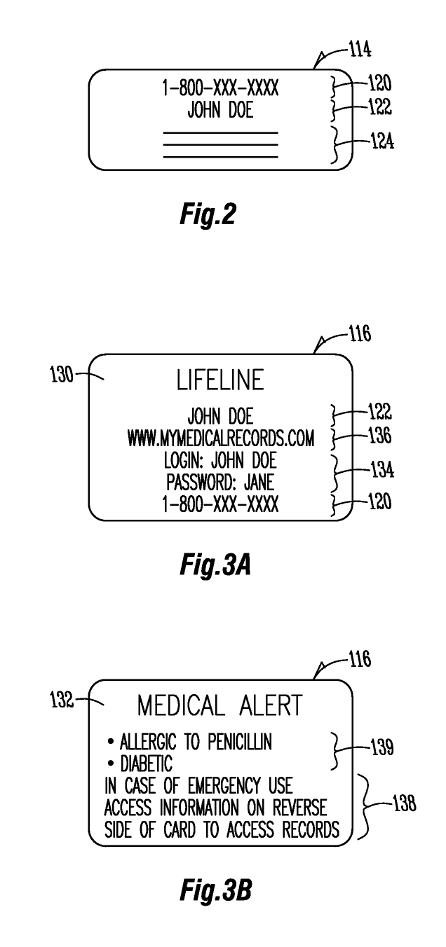

FIG. 2 illustrates one embodiment of a sticker 114 for a patient to give to their healthcare provider to request or instruct their healthcare provider to fax medical records to the toll free dedicated phone number associated with the patient. Although it is preferred that a sticker 114 be used because of the added convenience provided by being able to permanently or semi-permanently attach to a patient file at a healthcare providers office, the present invention contemplates that other types of documents could be used. The sticker 114 includes the LIFELINE phone number 120 which is the toll free dedicated phone number associated with the patient. Note that there is no pin number required which greatly simplifies the process of faxing documents. In addition, the name 122 of the patient is shown. There is also a written request 124 on the sticker 114 that instructs the healthcare provider to fax the records and explicitly gives permission to fax the healthcare record. The language of the written request 124 may vary as necessary to comply with any applicable laws. It should be appreciated that the sticker 114 provides great convenience to both an individual who wants to instruct their healthcare provider to give them access to their medical records as well as to the healthcare provider who can now easily provide the individual with access to their medical records. The present invention further contemplates that medical alert information can also be placed on the sticker 114. The types of medical alert information includes, without limitation, blood type information (i.e. ABO and Rhesus information), allergies to drugs, presence of a pacemaker, diabetes, epilepsy, or other conditions.

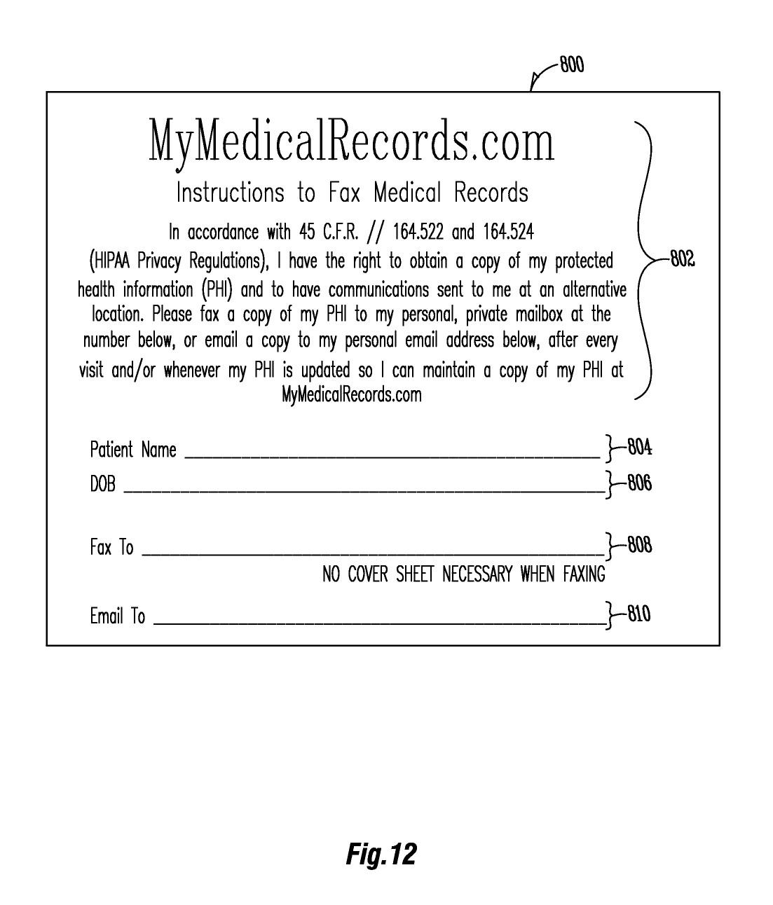

FIG. 12 illustrates another embodiment of such a sticker. Note that in FIG. 12, a sticker 800 is shown. The sticker 800 includes instructions to fax or email medical records 802 which serve to exercise a patients rights under 45 C.F.R.§164.522 and 45 C.F.R.§164.524 (HIPAA Privacy Regulations) to obtain a copy of their protected health information (PHI) and to have such communications sent to the patient at an alternative location. In particular, the instructions 802 instruct the healthcare provider to fax a copy of the PHI to a personal, private mailbox at a toll-free or local number after every visit and/or whenever the PHI is updated so that the patient can maintain a copy of their PHI. Alternatively, the instructions 802 provide for instructing the healthcare provider to email the records to specified email address 810.

The sticker 800 includes a region 804 for the patient to print or type their name and a region 806 for the patient to print or type their date of birth. There is also a region 808 for the fax number to which medical records are delivered. Preferably, the number is a toll-free fax or local number assigned to the patient. There is also a region 810 for an email address to which the medical records are to be submitted.

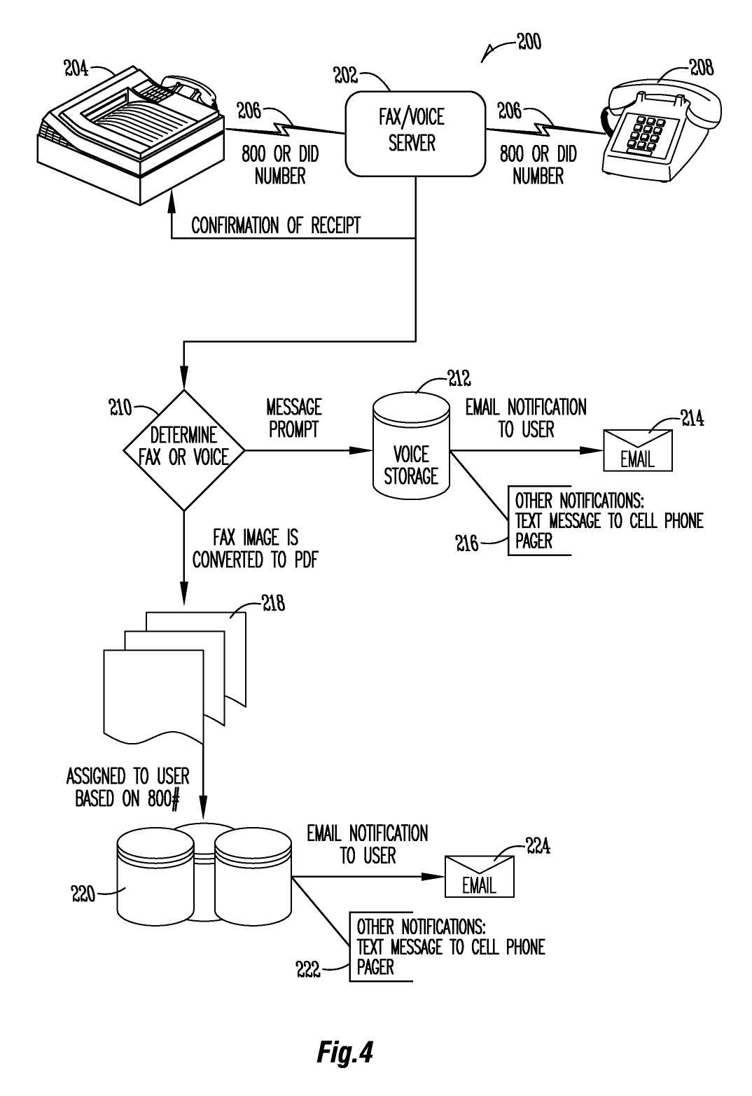

FIG. 3A and FIG. 3B illustrate one embodiment of a LIFELINE card 116. The LIFELINE card has a front side 130 and an opposite back side 132. The card 116 includes the name of the individual 122, a URL for a web site 136 which stores medical records for the individual. In addition there is access information 134 such a username and password. The card 116 also includes the toll free dedicated phone number 120 associated with the individual. On the back side 132 of the card 116 as best shown in FIG. 3B, medical alert information 139 is provided. The medical alert information 139 can include allergies which the individual has, medical conditions such as diabetes or epilepsy, the presence of a pacemaker, or other medical information that may be of great importance in evaluating or treating the individual in the case of a medical emergency. The medical alert information can further include blood type information (i.e. ABO and Rhesus information). Also, instructions 138 are provided on the card 116 to indicate how one could access complete medical records or information about the individual.

The present invention contemplates including the sticker 114 (or other permission/request document) and the LIFELINE card 116 in a welcome kit when an individual or family subscribes or signs-up for the service. In addition, from the web site associated with the service, preferably addition stickers and/or additional cards can be printed and information can be updated as necessary. Stickers and/or cards may be pre-printed with user information (such as name, lifeline number, allergies, etc.) from information in a database).

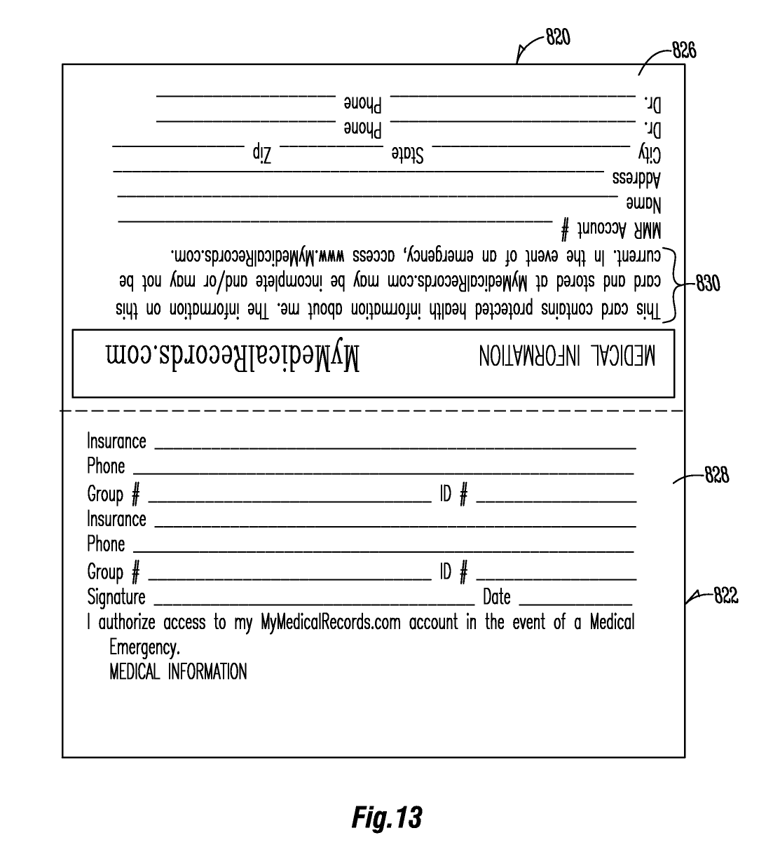

FIGS. 13 and 14 illustrate another embodiment of a wallet card of the present invention. The wallet card 820 includes a first side 822 and an opposite second side 824. As shown in FIG. 13, the first side 822 of the wallet card 820 has a first panel 826 and a second panel 828. The first panel 826 includes identifying information about an individual and emergency instructions 830. The emergency instructions 830 indicate that protected health information can be accessed, in an emergency, at a web site. The second panel 828 of the first side 822 of the wallet card 820 includes insurance information and signature of the patient.

As best shown in FIG. 14, the second side 824 of the wallet card 820 includes emergency contact information, including a secret question or passcode so that the emergency contact person can better verify that there is an emergency, and not a fraudulent notification. The second side 824 of the wallet card 820, also preferably includes information regarding current medications, allergies, blood type, and medical conditions which may be critical to providing appropriate emergency care. A magnetic strip may also be placed on the card which may encode the same or different information.

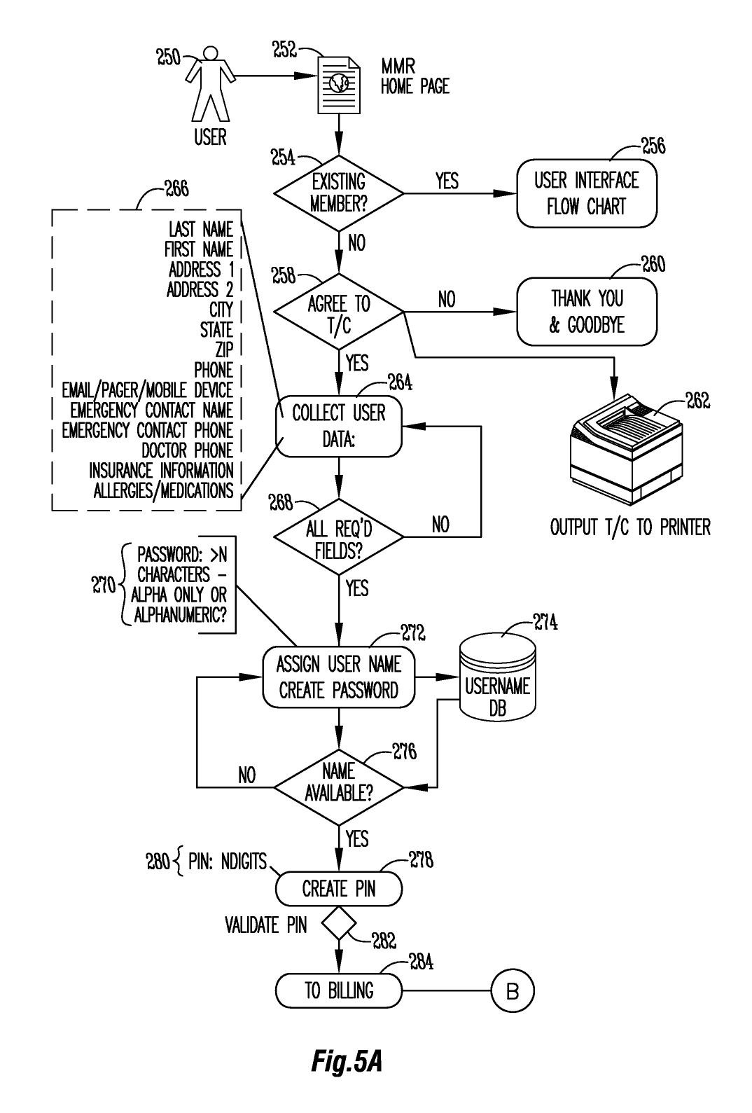

FIG. 4 illustrates one embodiment of a system of the present invention. As shown in FIG. 4, the system 200 includes a fax/voice server 202. The fax/voice server 202 is accessible by a fax machine 204 or a phone 208 through using a dedicated phone number 206. Preferably, the phone number 206 is toll-free as this increases the accessibility and convenience of the system. However, the phone number 206 could also be a direct dial phone number. When the fax/voice server 202 receives a call, a determination is made in step 210 as to whether the call is a voice call or a fax call. Where the call is a voice call, an interactive voice response (IVR) system is used to determine who the caller is, the purpose of the call, or other information, and then stores any voicemail message in voice storage 212. The system is adapted to notify the individual that there is a voicemail message through an email notification in step 214 and/or other types of notification in step 216. Other types of notification can include, but are not limited to text messages to a cell phone or pager. Thus, a healthcare provider can call the LIFELINE number 206 and leave a voicemail message for the individual and know that the communication is a private communication. Thus, the healthcare provider can leave private and confidential information, such as the results of a test, or the need to schedule a new appointment, or other information. The individual is alerted to the presence of the voicemail message and can then call-in to the fax/voice server 202 to check messages.

Where documents are faxed, fax images are collected and converted to portable document format (PDF) documents 218. Although, the PDF format is preferred, the present invention contemplates that other types of document conversions can be done as may be appropriate in a particular implementation of the present invention including TIFF, JPG, or other formats. Based on the dedicated phone number 206 used to send the documents, the faxed documents are assigned to a user account and stored in step 220. The individual is alerted via email that the documents have been sent in step 224. Alternatively, the individual is alerted via text messaging in step 222 that a fax has been sent.

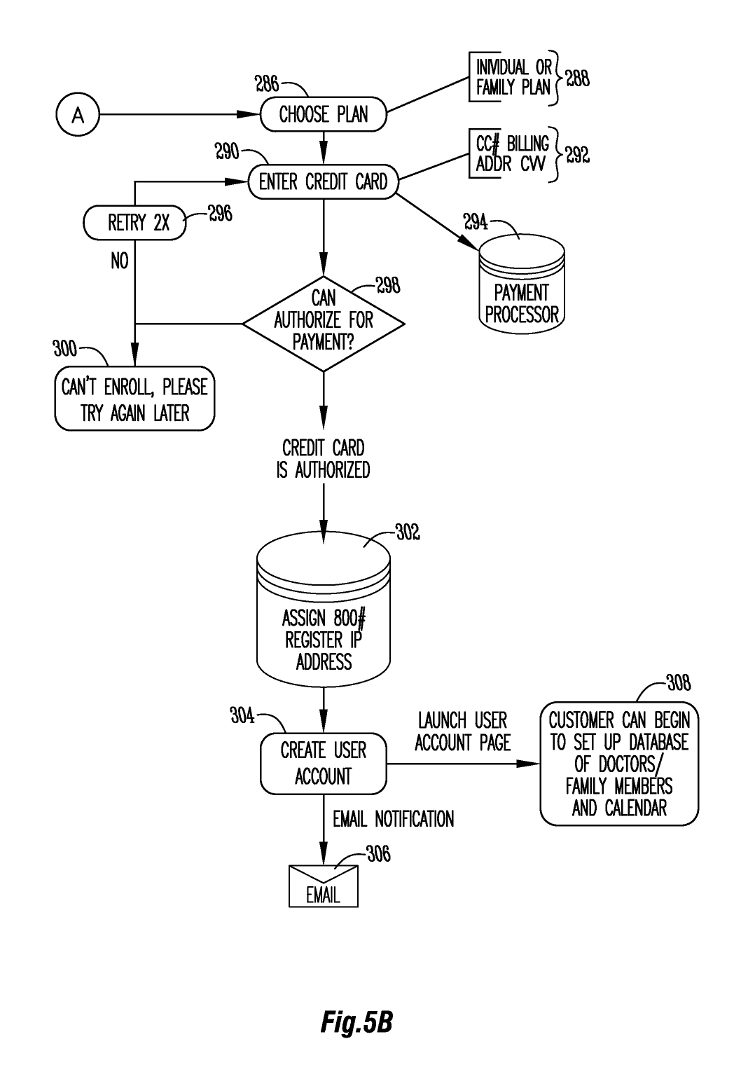

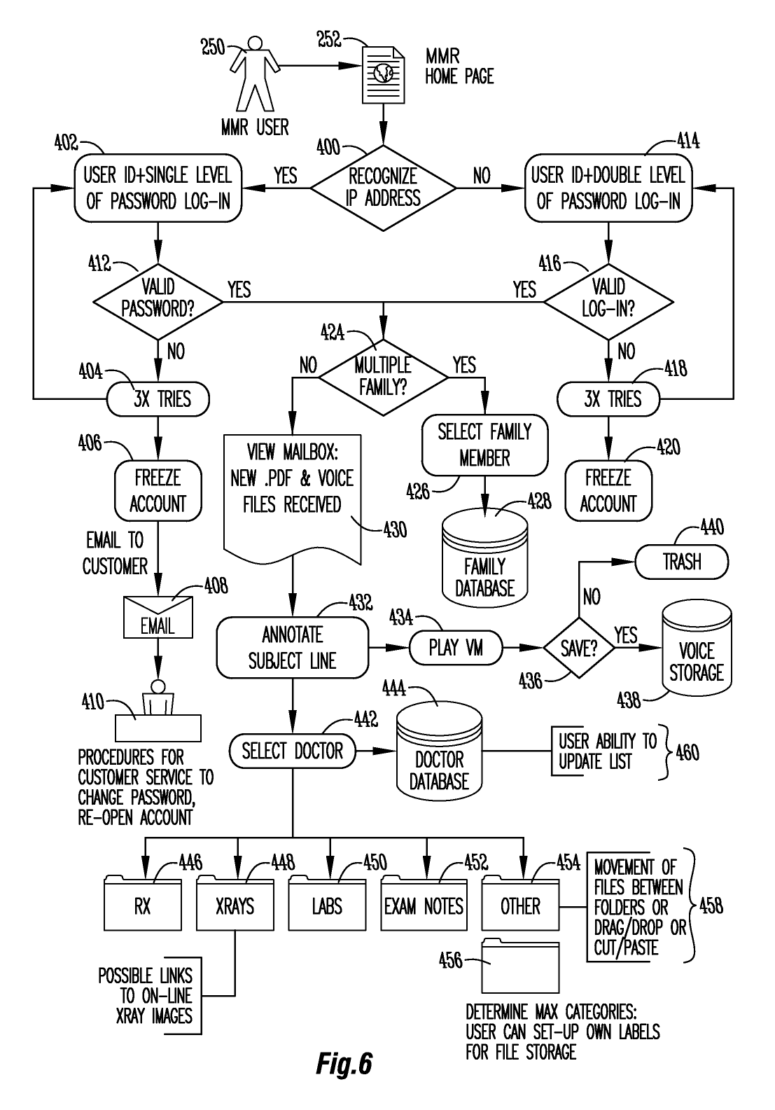

The web site of the present invention provides a convenient location to collect and store healthcare records and provide secure access to the records. It also provides a convenient way to enroll in a service for providing online access to health records. FIG. 5A and 5B provides one embodiment of an enrollment process In FIG. 5A, a user 250 accesses a home page 252 for a medical records web site. In step 254, a determination is made as to whether the user 250 is an existing member. If the member is, then in step 256 the user is provided access to their user interface as shown in FIG. 6. If not, then in step 258 a determination is made as to whether the user 250 agrees to terms and conditions of service. If not, then in step 260 the user is thanked for their interest but not allowed to continue. The user is also given the option or encouraged to output the terms and conditions to a printer in step 262 so that they can review them closely and maintain a copy for their records if they wish. If in step 258, the user agrees to the terms and conditions of service then in step 264 the system collects user data. User data 266 can include last name, first name, address information, city, state, zip code, phone number, email/pager/mobile device information, emergency contact name, emergency contact phone number, primary care physician phone number, insurance information, allergies and medications, and/or other information. If all fields are received in step 268, then in step 272 the system assigns a user name and password. It is to be understood that the user may also request a particular username and/or set their own password. Where a user selects their own password, then in step 270, a determination is made as to whether the password meets security requirements. For example, there may be a minimum number of characters required, or there must be at least one numeric character, or other requirements. Where the user is allowed to select their own name, in step 274, a username database is searched and in step 276 a determination is made as to whether or not the name is available. If it is, then in 278 the user is permitted to create a personal identification number (PIN). In step 280, a rule such as one requiring a particular number of digits or a particular minimum digits is applied. In step 282 the PIN is validated and the enrollment process proceeds to billing options in step 284. In FIG. 5B, the user is allowed to choose a plan in step 286. The individual could, for example, choose an individual or family plan from the plan options 288. In step 290, the user enters credit card information 292 which may include a credit card number, billing address, and CW number. This information is then submitted to a payment processor 294. In step 298, a determination is made as to whether the credit card information can be authorized for payment. If not, then the number of retries is determined in step 296 and the user is allowed to re-enter their credit card information in step 290. If there have already been two tries to validate credit card information, then in step 300 the individual is told that they can not enroll at this time and should try again later. If payment is authorized in step 298 then in step 302 a dedicated toll free phone number is assigned and an IP address associated with the user is registered. In step 304 a user account is created. In step 306 an email notification confirming registration is sent to the user. In step 308 the user can begin to setup their personal web site such as their database of doctors, family members, calendar, and otherwise configure their web site.

Where a calendar is used, the present invention contemplates that the calendar can be synchronized with an application such as Microsoft Outlook, a calendar program associated with a PDA, or other personal information manager.

After registration, the user can access the user interface of the web site as shown in FIG. 6. The user 250 can access the homepage 252. In step 400, a determination is made as to whether the system recognizes the ip address being used by the user as being associated with the user. If the ip address is not recognized then extra security measures are taken beginning in step 414. In step 414 a username and a double level of password log-in is required. If a valid log-in, then the process proceeds to step 424. If not, then in step 418, the number of invalid log-in attempts or tries is monitored and if it is three, then in step 420 the account is frozen. Returning to step 400, if the ip address is recognized as being associated with the user, then in step 402 a username and a single level of password log-in is required. In step 412 a determination is made as to whether or not the password is valid. If a valid password, then the process proceeds to step 424. If not, then in step 404 a determination is made as to the number of invalid attempts. After three invalid attempts, in step 406 the account is frozen and in step 408 an email is sent to the individual who may, in step 410, implement procedures to change the password and re-open the account.

Returning to step 424, a determination is made as to whether the account is associated with an individual or a family. If the account is associated with a family, then in step 426, the user can select the family member and access the family database 428. If, in step 424 the account is not a family account, then in step 430 the user can view their mailbox showing new PDF files and voice files. Preferably, these new files include date and time stamps so that the user can see when the files were received.

In step 432, the user is allowed to annotate the messages to better identify the messages in a manner that is convenient for the user. In step 434, the user can play the voicemail messages. In step 436, the user can choose to save the messages to voice storage 438 or to send the message to the trash 440. In step 442, the user can select a doctor to associate with the voicemail messages. For example, the doctor from which the voicemail or imaged document was received. Preferably the doctor is within the doctor database 444. If not, then in step 460, the user can update the doctor database 444 to include the doctor. The user can then organize the voicemail or document according to the user's preference into one or more file folders. Examples of file folders include RX 446, XRAYS 448, LABS 450, EXAM NOTES 452, OTHER 454. The user can make new file folders such as file folder 456 and identify it appropriately. The user interface offers functions 458 such as movement of files between folders, drag and drop, cut and paste, and/or other functions that will assist the user in organizing their records.

The present invention provides for each of the file folders to be protected with one or more additional passwords. Such an implementation is particularly useful in a number of contexts. For example, the use of multiple passwords allows information such as insurance information, financial information, or other proprietary information to be protected differently than the medical records.

Another example of where this extra layer of security can be useful is where a single account is shared by a family consisting of two parents and multiple children. Each parent may have their own folder separately password protected so that the other parent can not access their folder, but still allowing both parents to access the folders for the children.

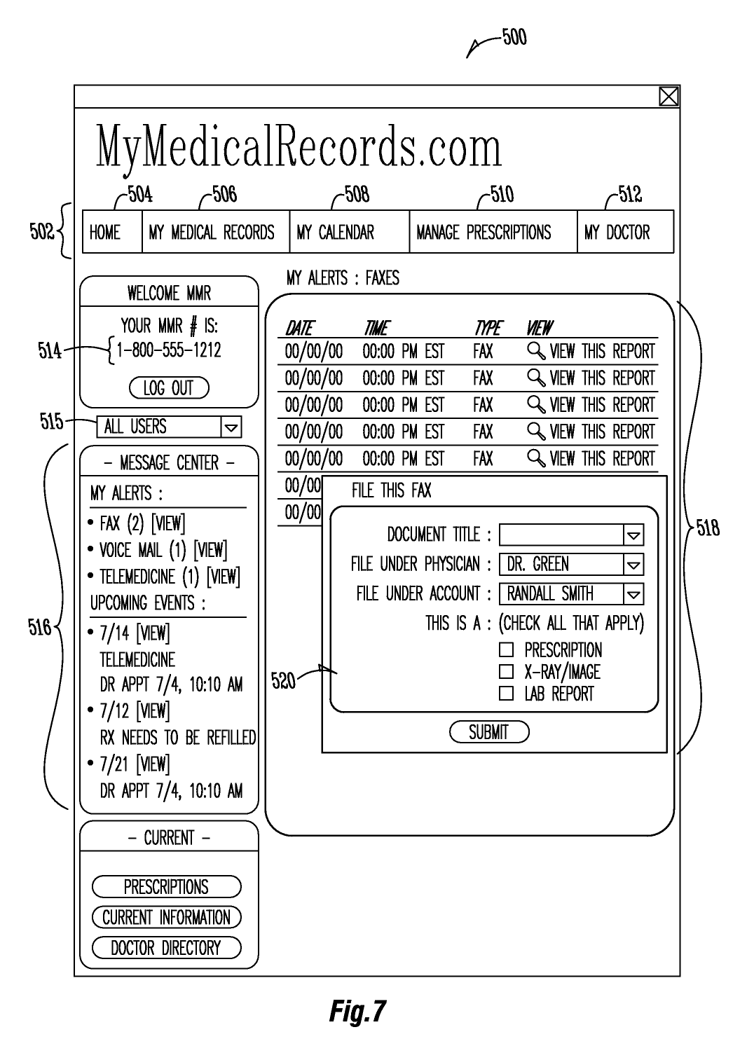

FIG. 7 illustrates one embodiment of a screen display of the present invention. In FIG. 7, the screen display 500 includes a menu bar 502 along the top with different menu items such as “Home” 504, “My Medical Records” 506, “My Calendar” 508, “Manage Prescriptions” 510 and “My Doctor” 512. The screen display 500 also includes a reminder to the individual of their LIFELINE toll free dedicated phone number 514. A message center 516 includes alerts as to recent faxes, voicemails, telemedicine records, doctor appointments, prescription refills, or other related events. The user can view the recent faxes 518, and for each fax, can file it using fax filing options 520 which allow the user to give a document title to the fax, associate a physician with the fax, file the fax under a particular account where the account is a family account, and identify the fax as a prescription, x-ray/image, or lab report.

It should also be appreciated that a user need not fax themselves documents. Instead, the user can upload scanned documents or other files in any number of formats.

Note also that the alerts may include telemedicine alerts to alert a user of the availability of new personal health records generated from monitoring data of a medical device or personal health monitoring device. Thus, a user can view the monitoring data, file the monitoring data, send the monitoring data to a health care provider or otherwise manage the monitoring data.

Note also that in addition to conventional doctor appointments, the appointments may be telemedicine appointments where the patient and health care provider are not physically present together but instead are communicating via a video conference. The present invention further contemplates that audio or video from the video conference may be used to create an additional personal health record.

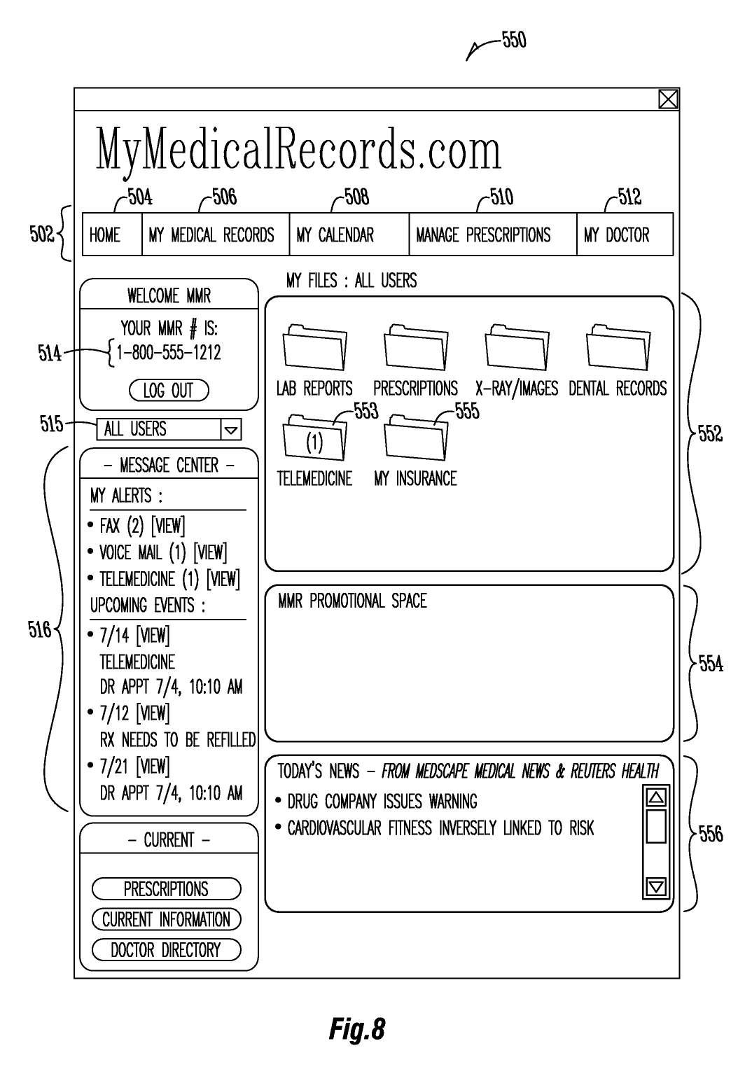

FIG. 8 illustrates another example of a screen display according to one embodiment of the present invention. In FIG. 8, the screen display 550 also includes a files section 552 wherein different folders are shown for storing and organizing information. This allows a user to store records in a manner appropriate for them. In one embodiment, the folders can include separate folders for lab reports, prescriptions, x-ray/images, dental records, lab reports, prescriptions, and all records. As shown in FIG. 8, there is a promotional space 554. The present invention allows for promotional material to be placed in the promotional space 554 that is of potential interest to the user. The promotional information can come from a third party source or advertiser. In additions, news information may be placed in a news information portion 556 of the web page. The news information can include breaking news regarding the medications that the patient is on, health and fitness news, or other news of potential interest or importance to the user. A telemedicine folder 553 is also shown. Monitored data from medical monitoring devices may be placed directly into the telemedicine folder 553. An insurance folder 555 is also shown. Insurance information may be placed in the insurance folder 555 and made available in the case of emergency. In addition, data received through a data portal to a service such as 4media may be placed in an appropriate folder including lab results, test results, prescriptions, or other information.

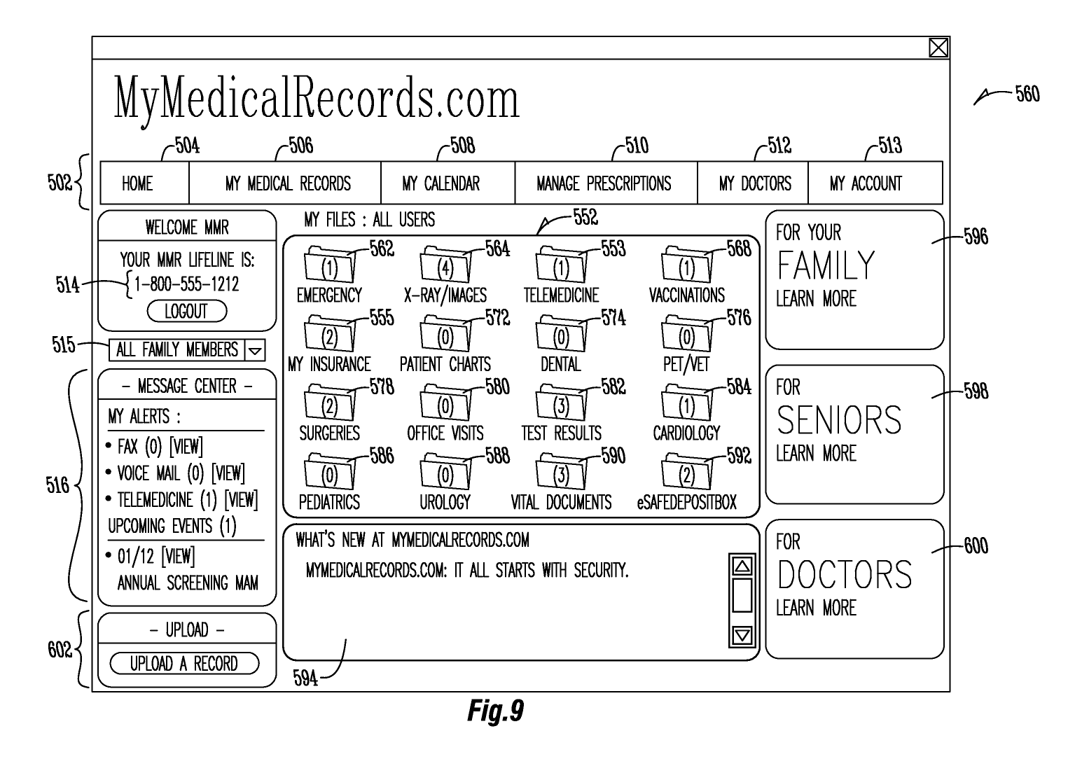

FIG. 9 is another example of a screen display 560 according to one embodiment of the present invention. Note that a MYACCOUNT option 513 is shown near the top of the screen display 560. Also note that a user is allowed to select a family member using the dropdown list box 515. There is also an upload record option 602 provided so that a user may upload files of various types directly to their account.

Shown in the MY FILES portion 552 are a plurality of file folders, including: EMERGENCY folder 562, X-RAY/IMAGES folder 564, TELEMEDICINE 553, VACCINATIONS 568, OBSTETRICS 570, PATIENT CHARTS 572, DENTAL 574, PET/VET 576, SURGERIES 578, OFFICE VISITS 580, TEST RESULTS 582, CARDIOLOGY 584, PEDIATRICS 586, UROLOGY 588, VITAL DOCUMENTS 590, eSAFEDEPOSITBOX 592. The various file folders shown provide a convenient method for users to organize their files. Note that each folder indicates how many files are stored within the file folder.

A WHAT'S NEW portion 594 allows users to learn about new features or other information. A FAMILY panel 596 can display information or links to information relevant to families. A SENIORS panel 598 can display information or links to information relevant to seniors. A DOCTORS panel 600 can display information or link to information relevant to doctors. Of course, the present invention contemplates that panels 596, 598 and 600 need not be present, and where present can be used to convey other types of information of potential interest to users.

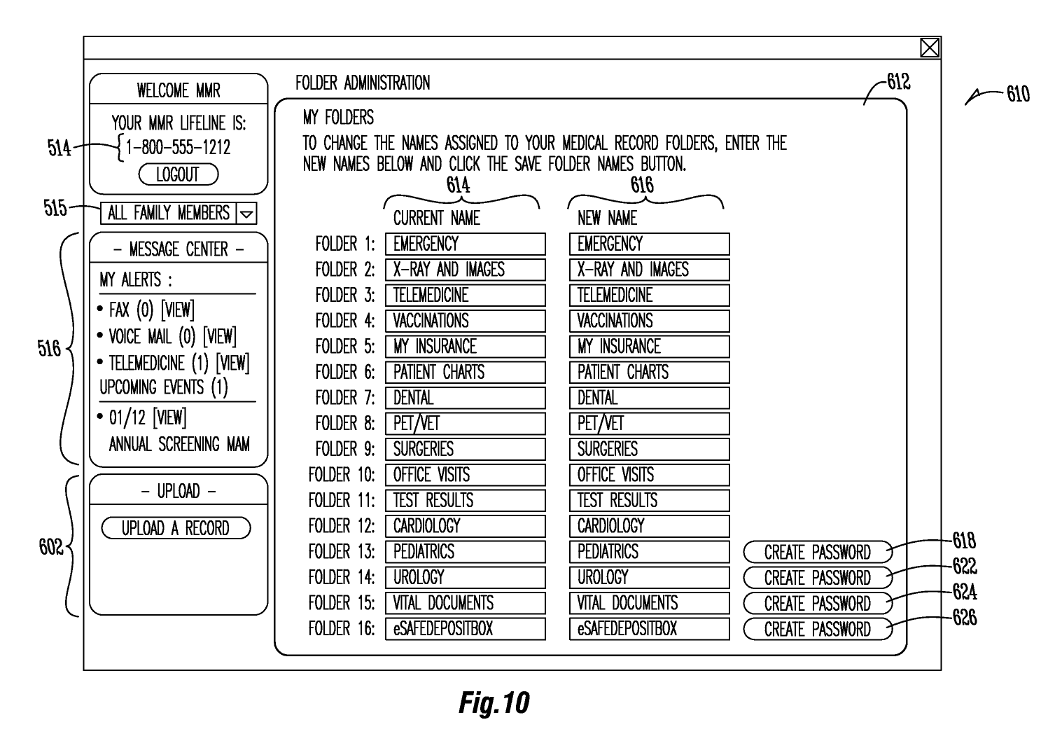

FIG. 10 is another example of a screen display according to one embodiment of the present invention. The screen display 610 allows for folder administration. A folder administration portion 612 includes a listing of multiple folders (16 shown) with a column 614 indicating the current name for each folder and a column 616 indicating the new name to be assigned to each folder. In operation a user can change the name of the folders to suit their particular needs. Note that at least a portion of the folders have a password associated with them. This provides an additional layer of security to these files.

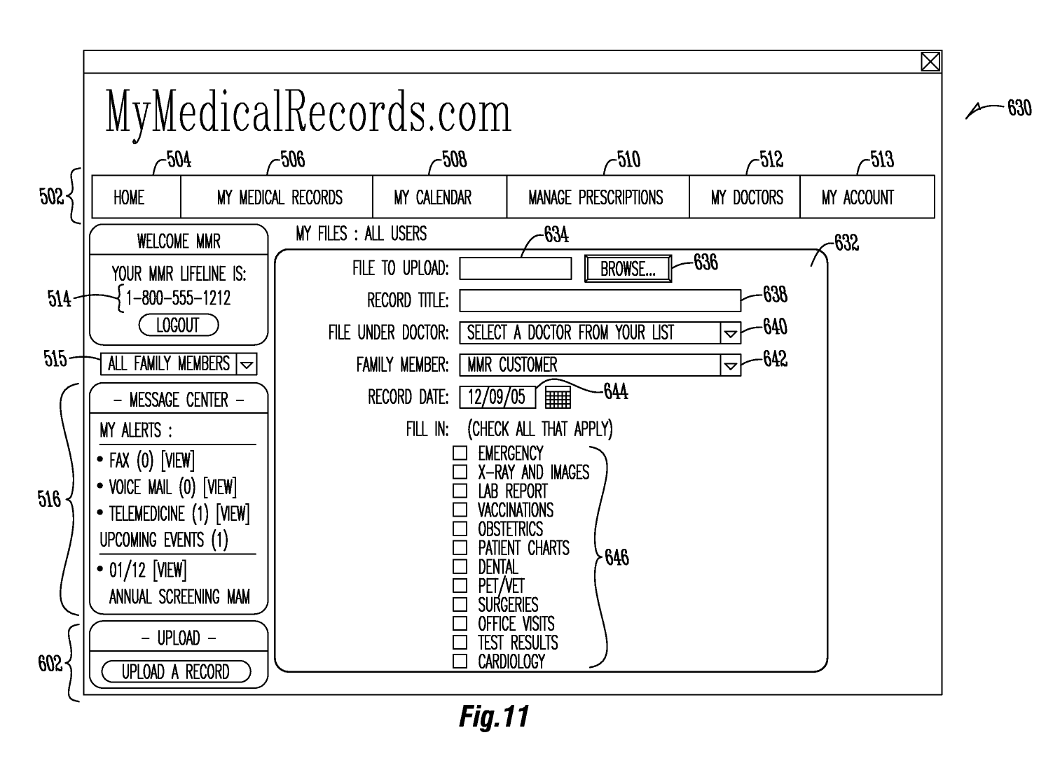

FIG. 11 is a screen display for an uploaded file feature according to another embodiment of the present invention. The screen display 630 allows for uploading a medical record 602. The upload a record window 632 allows the user to select a file to be uploaded 634 by browsing 636 to the location of the stored file. For example, if the user has chest x-rays saved in a picture format such as a jpeg, they would be able to browse 636 to the file and upload the file 634 to add to or to make current their present set of medical records. The upload a record window 632 also allows the user to record a title 638 for the file uploaded 634. Additionally, the uploaded a record window 632 allows the user to associate the file uploaded 634 with the appropriate doctor selected from a drop-down list 640. If the account is family or joint type account and allows storing medical records for multiple persons, the user may use the drop-down menu 642 to select the family member 642 to whom this newly uploaded file 634 should be associated with. The upload a record window 632 also allows the user to record a date 644 associated with the newly uploaded file 634. Lastly, the user has the option of selecting the individual folders 646 where he or she would like a copy of the newly uploaded file 634 to be saved. For example, the user may wish to save the chest x-rays in the x-ray and images folder as well as other folders, such as the emergency folder, lab report and/or surgeries folder. The upload a record window 632 allows the user to periodically update their personal medical records with important medical information and associate that information with the appropriate folders. The upload a record window 632 also makes it easy for the user to browse to and save medical files in electronic form in a convenient and organized manner.

In one embodiment, not only is a password required to access the website, but an additional password is required to access such a folder. This feature can be advantageous in a number of different situations. For example, a family may share an account, but each spouse may maintain certain files in confidence from the other. Or where healthcare information is accessed in an emergency (or through fraudulent use of an emergency card), the most private information which is protected with a second level of password protection remains secure. As shown there are buttons 618, 622, 624, 626 for providing a secondary level of password protection.

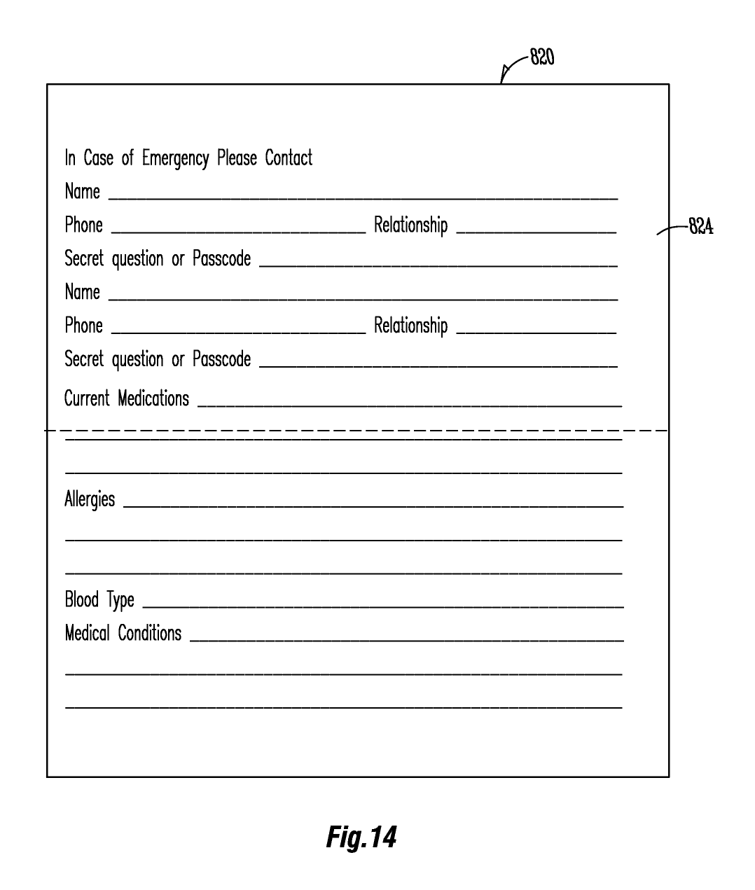

FIG. 15 illustrates one embodiment of using the health-related information collected to provide additional benefits to a consumer. For example, the present invention allows for a system 800 that includes a personal health records database 850 and a drug interactions database 852 operatively connected to an analysis system 854. The analysis system 854 is operatively connected to a drug interaction reporting component 856. The personal health records 850 includes information regarding which prescription drugs are being taken by the user. The drug interactions database 852 includes information regarding known interactions between different drugs. The analysis system 854 analyzes the prescription drugs taken by the user to determine if there is any known interaction that may be adverse in any way to the user. Based on the results of this analysis, the drug interaction reporting component 856 reports the results to the user, their pharmacist, doctor, or other healthcare provider as appropriate. The present invention contemplates that drug interaction reporting 856 can be reported in different ways to different people based on factors such as user preferences regarding the drug interacting reporting, the severity or certainty of a determined adverse drug interaction, or otherwise. The present invention contemplates that in addition to drug interaction analysis and reporting, other types of analysis and reporting can be performed on the personal health records. One of the advantages of the present invention is that it allows for a convenient method to build and maintain complete and up-to-date health records, thus allowing the personal health records to be analyzed in any number of ways.

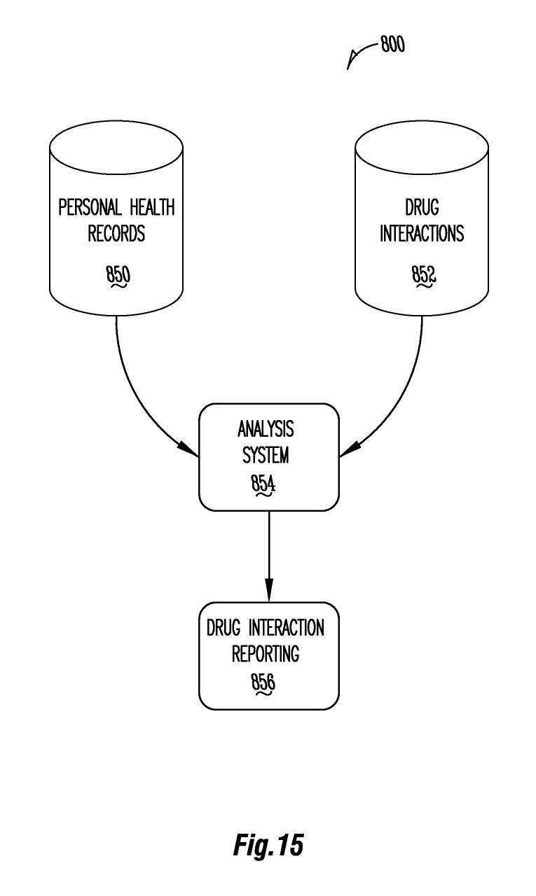

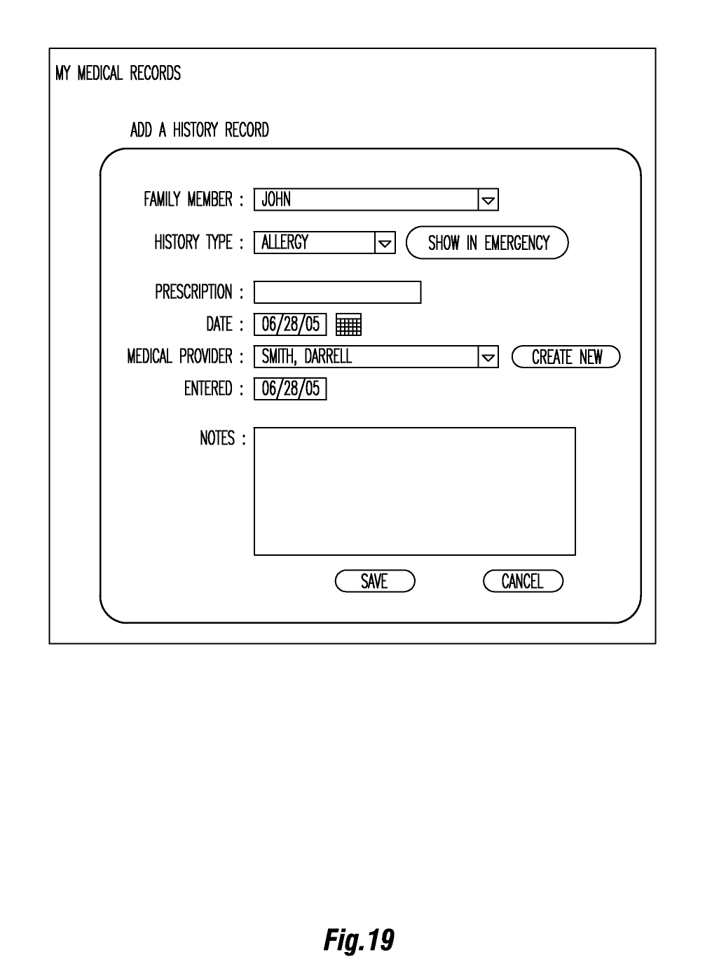

FIG. 16 through FIG. 25 illustrate various screenshots of one embodiment of the present invention which provides for providing emergency access to the personal health records associated with a consumer. The emergency password can be assigned to every member of a family. The emergency password—which is different from the normal account log-in—can be used by a doctor or other medical personnel to access critical information in the account in the event of a crisis situation in which a consumer is not able to communicate emergency information. The emergency password preferably is included on a wallet card along with an identifier for the web site to be accessed and instructions for accessing the emergency information.

The emergency password feature allows a consumer to determine which information will be accessible when the emergency password is used. The consumer is in control of their private medical information, even in the event of an emergency. The consumer pre-determines what information they want a doctor, first responder, or other medical personnel to access. This can include what folders are shown, where personal health information is organized into folders. This can also include what items, such as medical history items are shown accessible. Preferably, if an item is not accessible, it is not even shown to preserve maximum privacy for the consumer.

For example, a user can make the telemedicine folder available through use of the emergency password. Thus, where monitoring data associated with medical devices is collected and placed in the telemedicine folder, a health care provider can access this data through the emergency login.

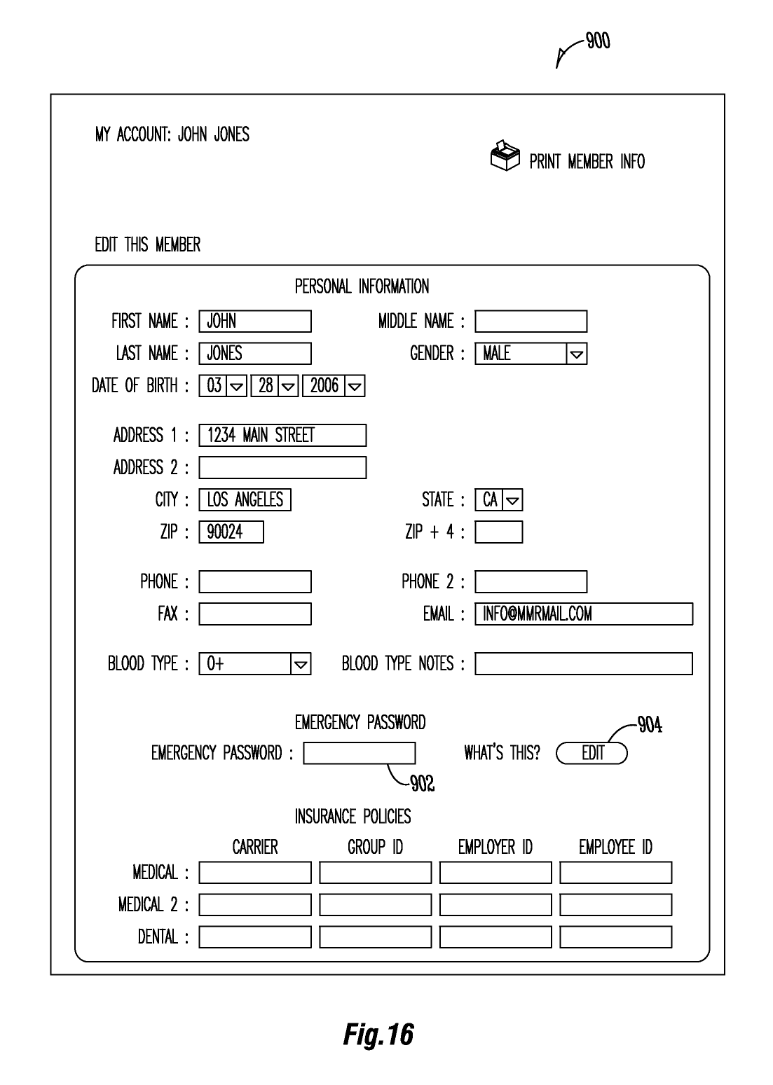

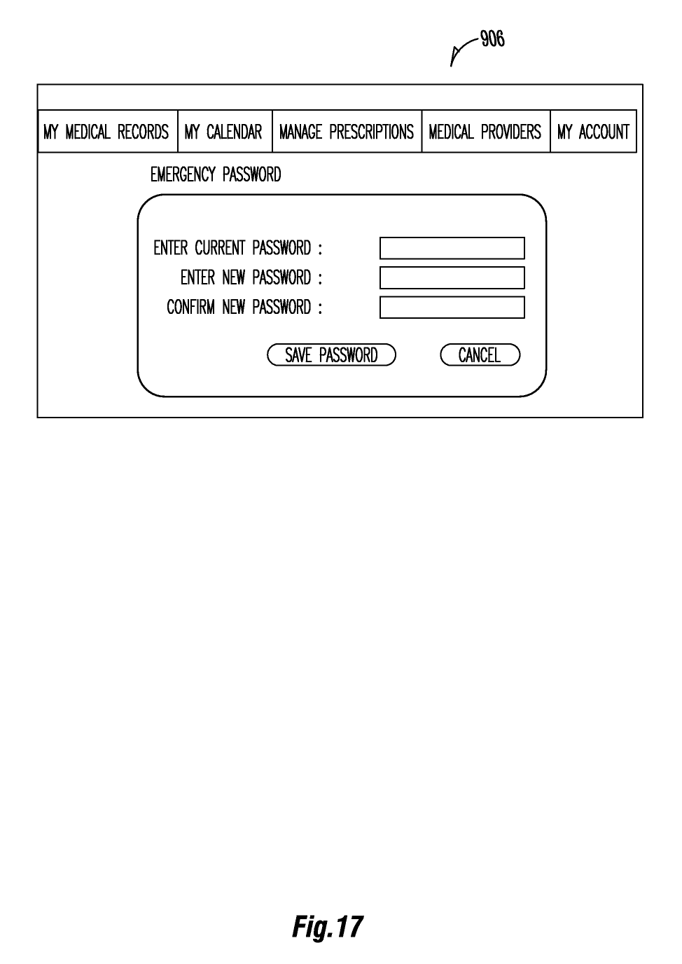

FIG. 16 illustrates a screen display 900 which includes an input box 902 for an emergency password and an “Edit” button 904. After pressing the “Edit” button 904, the screen display 906 of FIG. 17 appears and the consumer can set an emergency password. Next, in FIG. 18, the consumer can select which folders are to be displayed when the emergency password is used to access information. Note that folders are marked as “ACCESSIBLE” or “NOT ACCESSIBLE.”

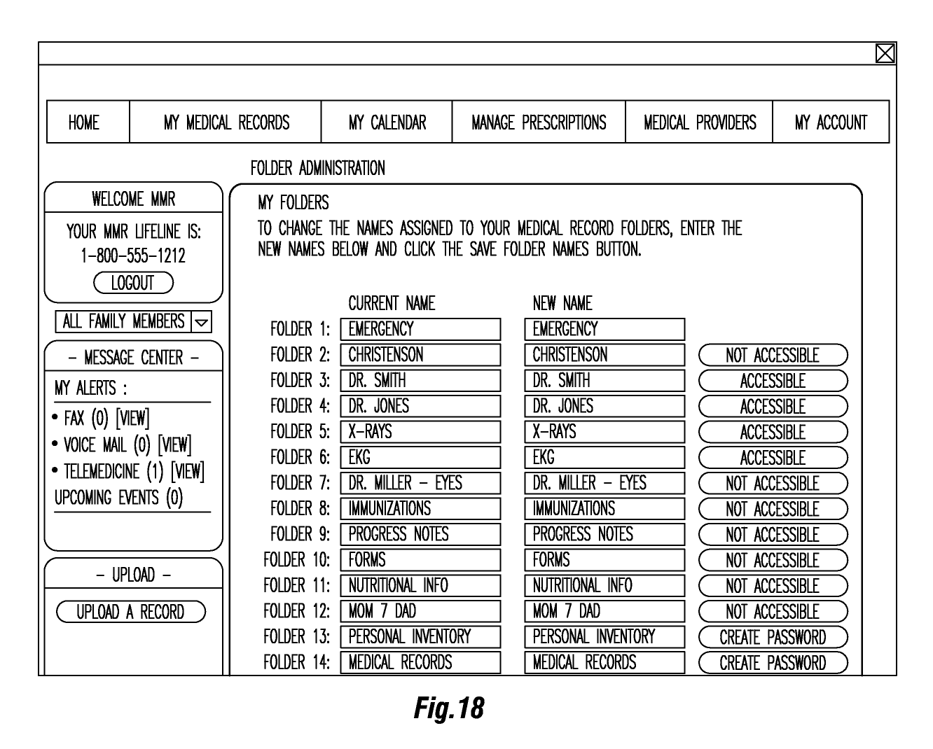

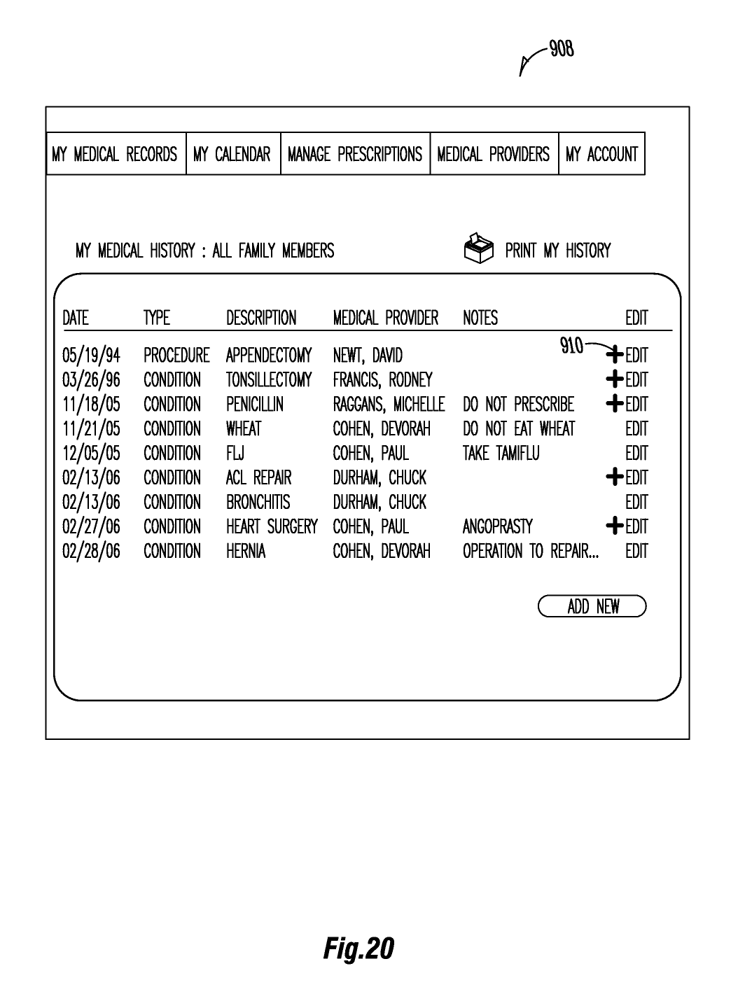

FIG. 19 illustrates medical history items. When new medical history items are added, the consumer can determine whether they want that information shown in case of an emergency. FIG. 21 shows a screen display with medical history items that specifies which items will be shown in case of emergency. An indicator next to each item, such as a red cross 910, indicates that the medical history item will be shown in case of emergency.

FIG. 21 is a screen display 912 of a web site which allows a doctor or other health professional to access emergency information in the event of an emergency. Note there is a separate button 914 for an emergency login. The emergency login button 914 is conspicuously placed so that it may quickly be found in case of emergency.

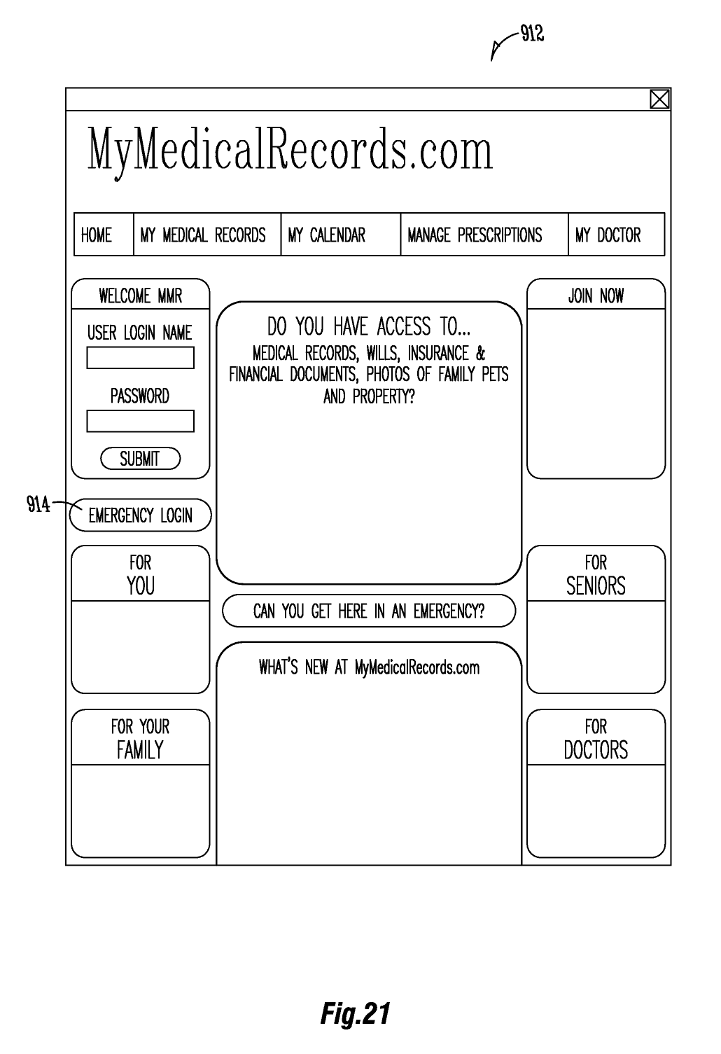

FIG. 22 is a screen display which collects basic contact information when an emergency login is made. The emergency password is validated as a part of the information collection process. The present invention contemplates that this basic information can be used in any number of ways. This information may be stored so that the consumer has a record of who accessed this information. In addition, the present invention contemplates alerting the consumer or the consumer's emergency contacts that an emergency log-in has been made, such as through a phone call, page, or email.

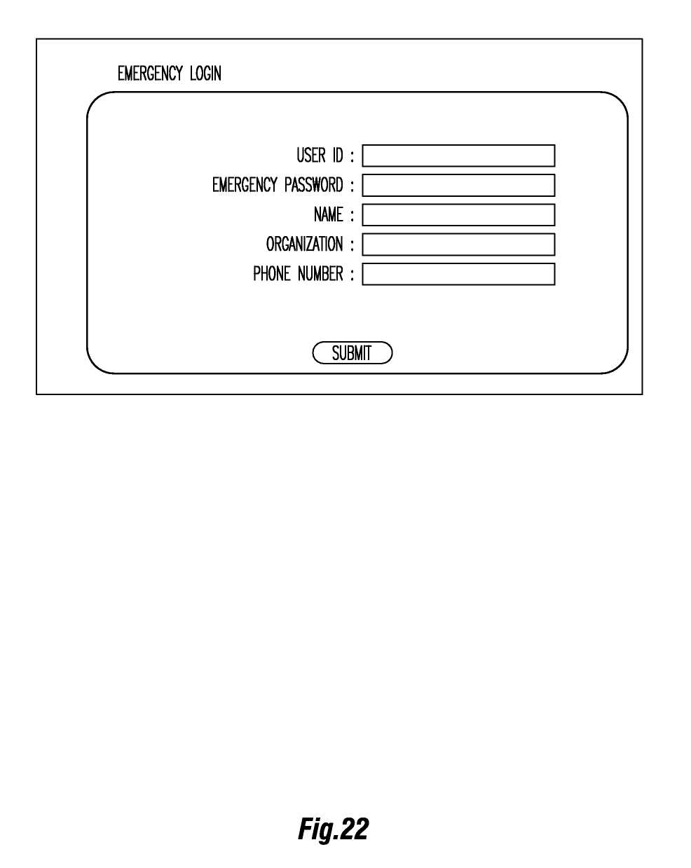

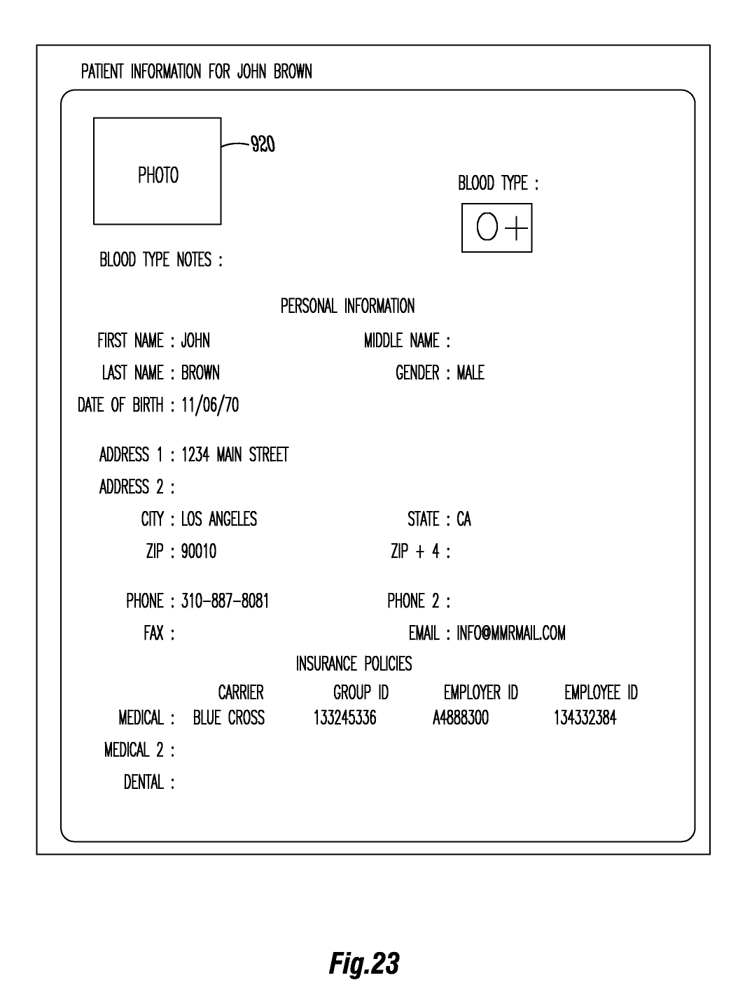

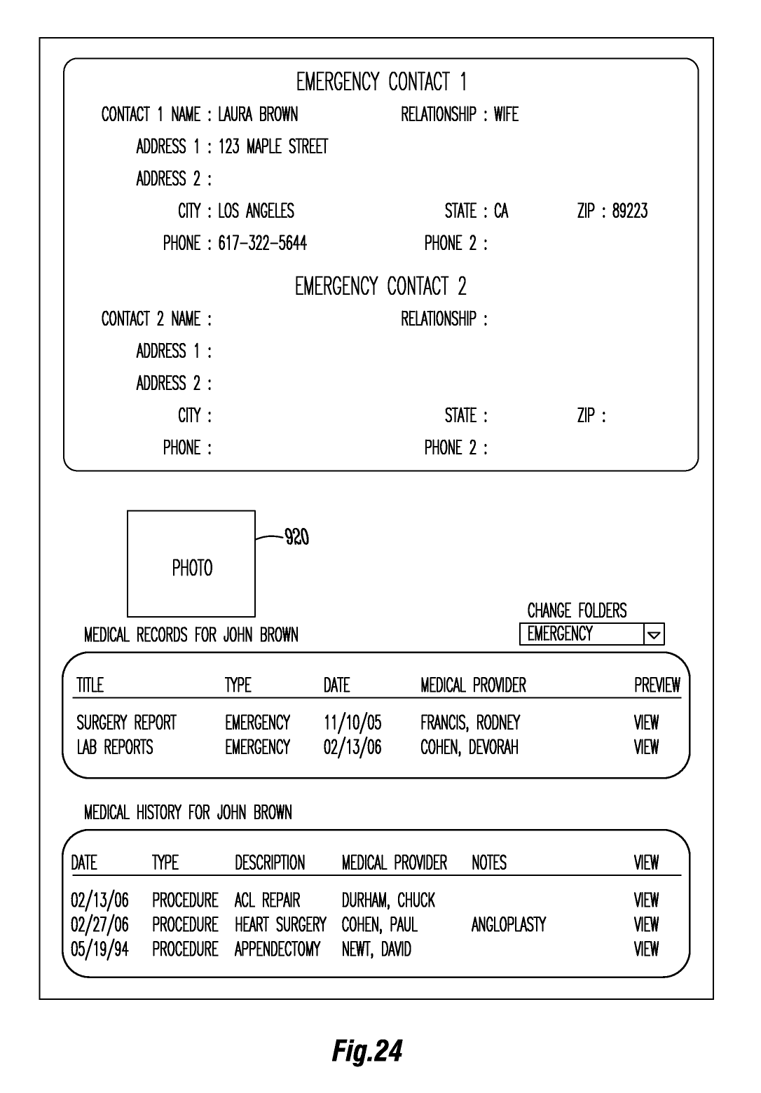

FIG. 23 and FIG. 24 illustrate one embodiment of the most critical information and records which are provided in case of an emergency. Additional information can be accessed from this screen. Note also that in both FIG. 23 and FIG. 24, a photo 920 of the individual may be shown. Having the photo 920 readily available helps first responders or other emergency care providers to verify that they have correctly matched the emergency card with the correct individual, if no one is able to confirm identity of the individual. For example, FIG. 25 illustrates prescription information which can be accessed.

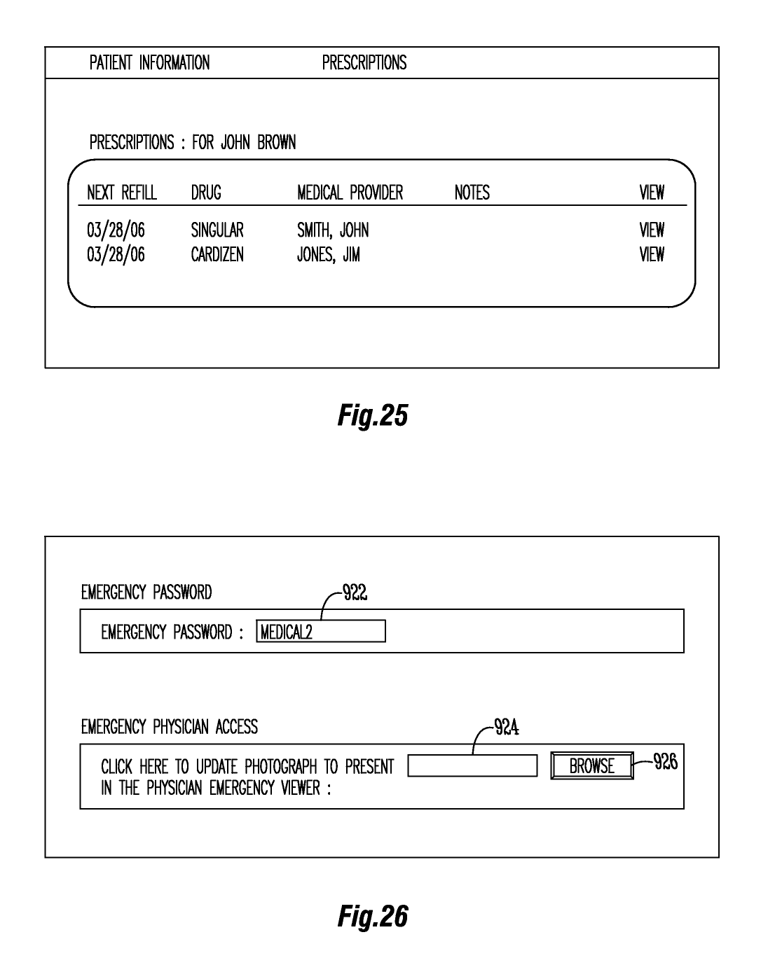

FIG. 26 illustrates a portion of a screen display that allows a user to specify an emergency password 922 as well as upload a photograph or other image file 924. A browse button 926 may be provided to assist the user in identifying the photograph or image file.

Thus, using the emergency password feature, a doctor or other medical or health personnel can quickly see complete information. The emergency password feature, however, does not allow others to add, edit, delete, re-file or otherwise change any of the account information. Thus, the consumer maintains control over their personal health records. In addition, the consumer maintains control over their personal health records by being able to limit access to personal health records by choosing which records are accessible and which records are not.

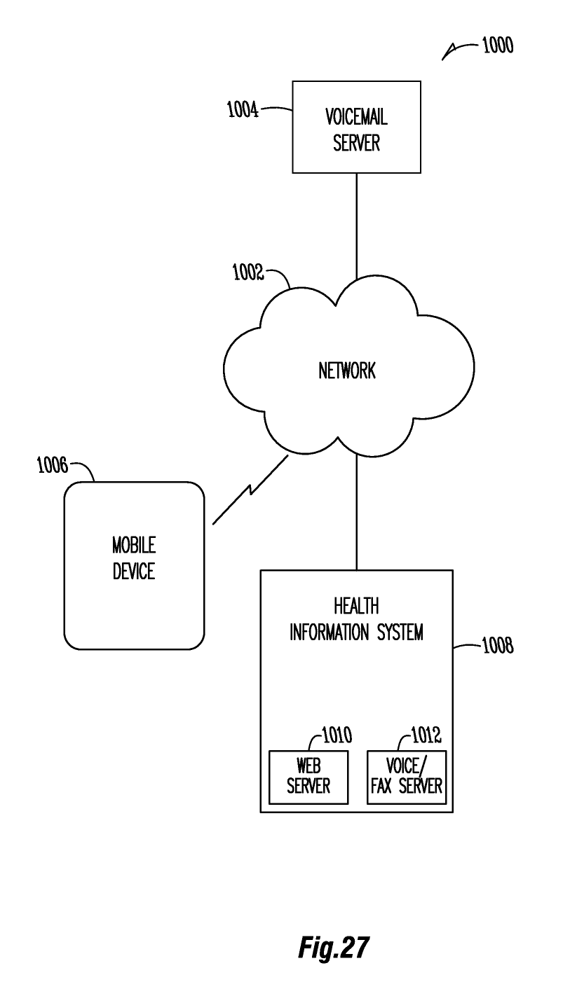

FIG. 27 illustrates example of a system 1000 using a mobile device to send voice mails or fax documents into a health information system. As shown in FIG. 27, a mobile device 1006 such as a phone, tablet, or other mobile device is in operative communication with a network 1002 which may be a telecommunications network. A voice mail server 1004 associated with a carrier used by the mobile device 1006 is operatively connected to the network. The present invention allows the voice mail server 1004 to be operatively connected to the health information system such that voice mails may be communicated directly into the health information system 1008. Similarly, faxes or files may be communicated from the mobile device through the network and to the health information system 1007. The health information system 1008 may have a web server 1010 or a voice/fax server 1012.

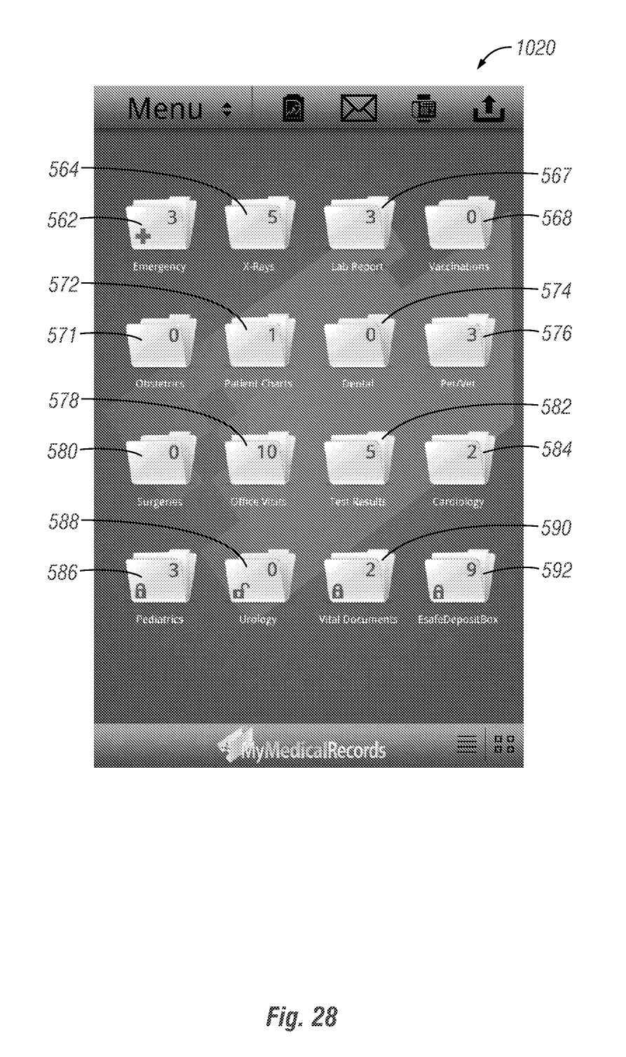

FIG. 28 illustrates a screen display 1020 for an app executing on a mobile device according to one embodiment. As shown in FIG. 28, there are a plurality of different folders including an emergency folder 562, an x-rays folder 564, a lab report folder 567, a vaccinations folder 568, an obstetrics folder 571, a patient charts folder 572, a dental folder 574, a pet/vet folder 576, a surgeries folder 580, an office visits folder 578, a test results folder 582, a cardiology folder 584, a pediatrics folder 586, a urology folder 588, a vital documents folder 590, and an esafedepositbox folder 592. Note that each folder may have a number appearing on it to indicate the number of documents filed in the folder. In addition, icons representing padlocks may be shown on the folders to indicate that the folders may have additional passwords associated with them.

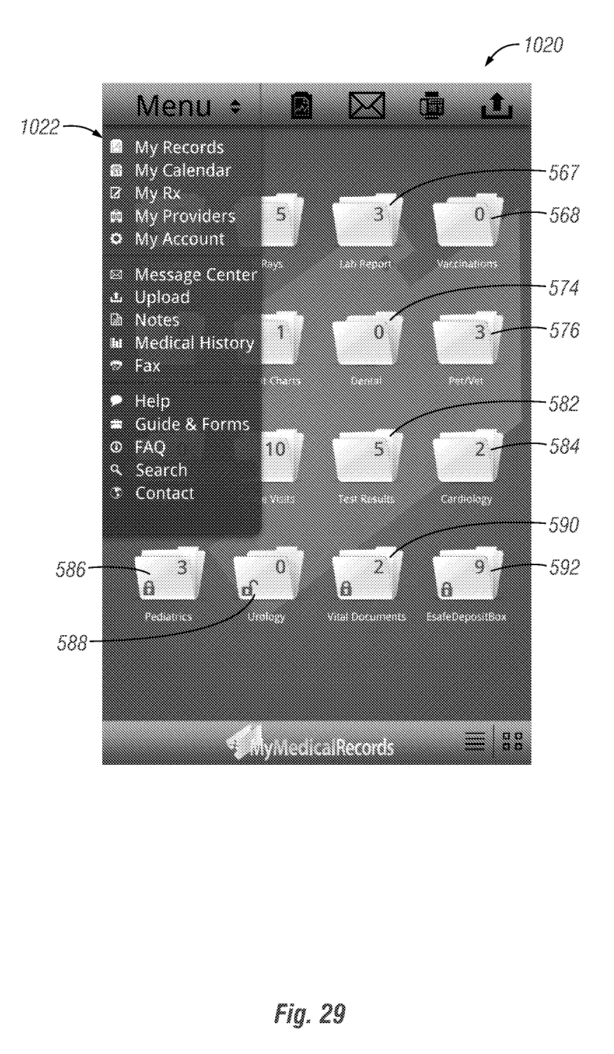

FIG. 29 illustrates a screen display for the app of FIG. 28 where the menu 1022 has been selected and menu selection items are shown. Menu selection items include “My Records”, “My Calendar”, “My Rx”, “My Providers”, “My Account”, “Message Center”, “Upload”, “Notes, “Medical History”, “Fax”, “Help”, “Guide & Forms”, “FAQ”, “Search”, and “Contact.”

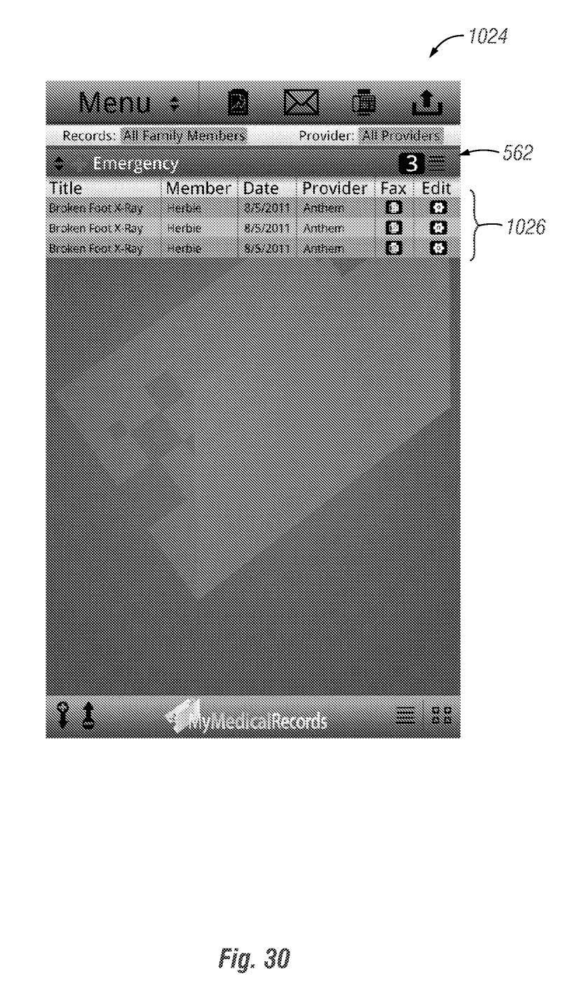

FIG. 30 illustrates a screen display 1024 for the app showing examples of records 1026 that are available when the emergency view is shown, including files in the emergency folder 562.

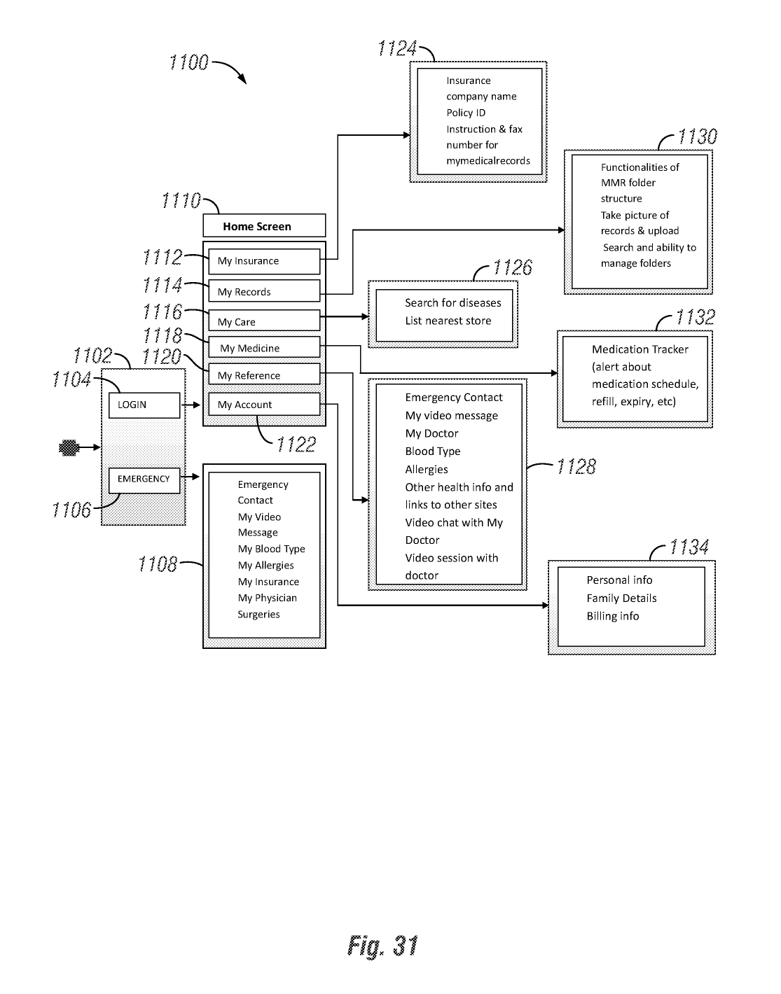

FIG. 31 is a block diagram describing one example of a mobile app. The app 1100 allows for login 1102 either as a normal login 1104 or an emergency log-in or emergency access 1106. Where there is an emergency log-in, then a screen 1108 may be displayed to provide information such as emergency contact information, “My Video Message”, “My Blood Type, “My Allergies, “My Insurance, “My Physician”, and “Surgeries.” Thus, in the case of an emergency a health care provider or first responder can receive immediate relevant information about the individual. The “My Video Message” also allows an individual to convey whatever information they want to share with others in the case of an emergency.

When a normal log-in is performed a home screen 1110 is shown which allows a user to select various functions including “My Insurance” 1112, “My Records” 1114, “My Care” 1116, “My Medicine” 1118, “My Reference” 1120, and “My Account” 1122. For example, when a user selects “My Insurance” a screen display 1124 may be shown which displays insurance information such as an insurance company name, a policy ID, and instructions and a fax number for records.

When a user selects the “My Records” function a screen 1130 may be displayed to provide the functionalities of the MMR folder structure such as those shown in FIG. 28. Additional functionalities include the ability to take a picture of records using the mobile device and upload that picture, and the ability to search and manage folders and records contained therein.

When a user selects the “My Care” function, a screen 1126 may be displayed to allow a user to search for diseases, locate nearby stores, or related functionalities.

When a user selects the “My Medicine” function, a screen 1132 may be displayed to provide a medication tracker to provide or set alerts about a medication schedule including information about refills, expirations, and other information.

When a user selects the “My Reference” function, a screen 1128 may be displayed to include information such as emergency contact information, my video message, my doctor, blood type, allergies, other health information and links to web sites, video chat with my doctor, and video session with doctor.

When a user selects the “My Account” function, a screen 1134 may be displayed to include personal information, family details, and billing information.

The present invention further contemplates that there may be a first mobile app and a second mobile app. The first mobile app may provide functionality associated with accessing the personal health record management system through a web portal which may also be referred to as a patient portal. In addition, the first mobile app may include additional features such as the ability to video chat with a health care provider or have a video session with a doctor. Preferably, the video chat or video session may be stored as a personal health record. In addition, the first mobile app allows for mobile uploads such as through photos of medical records, videos (such as for advanced directives or of patient encounters or otherwise).

The first mobile app may also provide for integrated video chat with health care providers, medication trackers, and other features. The first mobile app may also use location based services. Location based services may be used to identify the nearest pharmacies or the nearest pharmacies able to fulfill a prescription, provide directions to a particular health care provider, or other purposes.

The second mobile app may be an emergency app and provides a mobile version of the wallet card previously described. Preferably an icon for launching the emergency app is present on the home screen of the mobile device. The icon preferably communicates that it is to be used in case of emergency. Once the emergency app is selected, the user can bypass password security and go straight to an emergency screen displaying a photo of the patient, emergency contact information, and other emergency information. The emergency information may also include documents stored in the emergency folder such as wills, advanced health directives, and other types of documents. The emergency information may also include video advanced directives or other type of information. Alternatively, a single mobile app may provide for both types of functionality such as that shown in FIG. 31.

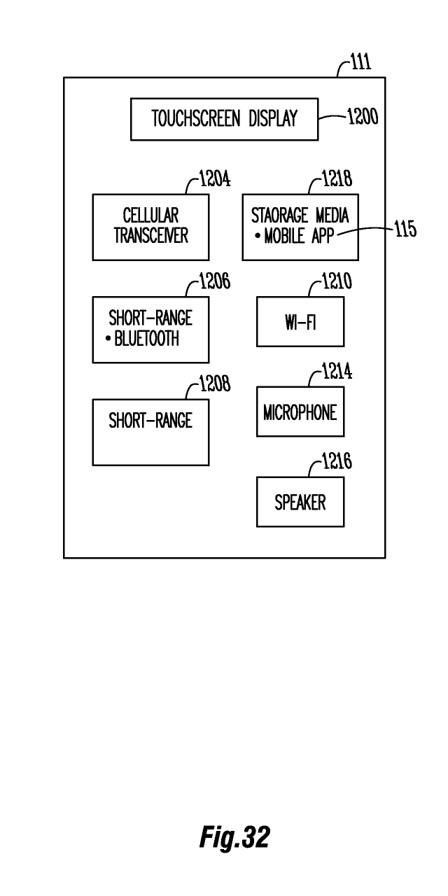

FIG. 32 illustrates a block diagram of one example of a mobile device 111. The mobile device 111 includes a touchscreen display 1200, a cellular transceiver 1204, a short range transceiver such as a BLUETOOTH transceiver 1206, a camera 1208, a Wi-Fi transceiver 1210, a microphone 1214, and a speaker 1216. The mobile device 111 further includes a machine readable storage media 1218 which may store the mobile app 115. The short range transceiver 1206 may be used to communicate with personal health monitoring devices so as to create health records containing data from the personal health monitoring devices. As previously explained, the camera 1208 may be used to image documents or to take video for a video message, videos of advanced directives, videos of patient encounters, video chat with a health care provider, or a video session with a health care provider.

The present invention is not to be limited to the specific disclosure provide herein. The present invention contemplates numerous variations as may be appropriate in a particular context, environment, or situation. This may include the type of mobile device, the specific functions of the mobile app, the specific functions of the portal, and other variations, options, and alternatives.

What is claimed is:

1. A method for managing health records on a mobile device, the method comprising:
providing a mobile application stored on a machine readable storage medium on the mobile device;
executing the mobile application on the mobile device to provide for (a) accessing health records using the mobile device, (b) receiving health records at the device, and (c) creating health records using the device.

2. The method of claim 1 wherein the accessing the health records using the mobile device comprises providing a user interface with folders for organizing the health records.

3. The method of claim 1 wherein the receiving the health records at the device comprises receiving a fax directed to a phone number of the device and storing the fax as a health record.

4. The method of claim of claim 1 wherein the receiving the health records at the device comprises receiving a voicemail directed to a phone number of the device and storing the voicemail as a health record.

5. The method of claim 1 wherein the creating the health records using the device comprises creating an image of a document using a camera of the device and storing the image of the document as a health record.

6. The method of claim 1 wherein the creating the health records using the device comprises creating a video using a camera of the device and storing the video as a health record.

7. The method of claim 6 wherein the video is associated with a video chat between a user of the device and a health care provider.

8. The method of claim 6 wherein the video is associated with a video message accessible using the mobile device in event of emergency through use of an emergency login of the mobile application.

9. The method of claim 1 wherein the creating the health records comprises receiving a wireless communication from a health monitoring device and creating a health record from data within the wireless communication.

10. The method of claim 1 wherein the mobile application requires a first login and an emergency login and wherein a subset of health records is available when the emergency login is used to access the mobile device.

11. The method of claim 10 wherein the first login is performed using voice identification.

12. The method of claim 1 wherein the executing the mobile application on the mobile device further provides for (d) providing a medication tracker.

13. The method of claim 1 wherein the executing the mobile application on the mobile device further provides for location based services associated with health care.

14. A mobile app stored on a machine readable storage medium, wherein executing the mobile app on a mobile device provides for performing steps of:
(a) accessing health records using the mobile device;
(b) receiving health records at the mobile device; and
(c) creating health records using the mobile device.

15. The mobile app of claim 14 wherein the accessing the health records using the mobile device comprises providing a user interface with folders for organizing the health records.

16. The mobile of app of claim 15 wherein one or more of the folders is password protected.

17. The mobile app of claim 14 wherein the receiving the health records at the device comprises receiving a fax directed to a phone number of the device and storing the fax as a health record.

18. The mobile app of claim 17 wherein the receiving the health records at the device further comprises receiving a voicemail directed to a phone number of the device and storing the voicemail as a health record.

19. The mobile app of claim 18 wherein the creating the health records using the device comprises creating an image of a document using a camera of the device and storing the image of the document as a health record.

20. The mobile app of claim 19 wherein the creating the health records using the device further comprises creating a video using the camera of the device and storing the video as a health record.

21. The mobile app of claim 20 wherein the video is associated with a video chat between a user of the device and a health care provider.

22. The mobile app of claim 20 wherein the video is associated with a video message accessible using the mobile device in event of emergency through use of an emergency login of the mobile application.

23. The mobile app of claim 20 wherein the creating the health records further comprises receiving a wireless communication from a health monitoring device and creating a health record from data within the wireless communication.

24. The mobile app of claim 23 wherein the mobile application requires a first login and an emergency login and wherein a subset of health records is available when the emergency login is used to access the mobile device.

25. The mobile app of claim 24 wherein the first login is performed using voice identification.

26. The mobile app of claim 14 wherein steps further comprise (d) providing a medication tracker.

27. The mobile app of claim 14 wherein the mobile app further provides for location based services associated with health care.

28. A method for providing meaningful access to health records, the method comprising:
providing a portal for accessing the health records through a web-site using a web-enabled device;
providing a mobile application stored on a machine readable storage medium of a mobile device for accessing the health records;
making available the health records to a user logging into the web-site using the web-enabled device or logging into the mobile application of the mobile device;
wherein the portal provides a first set of functions for receiving health records and creating health records and wherein the mobile application provides a second set of functions for receiving health records and creating health records with a subset of the second set of functions not within the first set of functions.

29. The method of claim 28 wherein the second set of functions comprises creating a video using a camera of the mobile device and storing the video as a health record.

30. The method of claim 29 wherein the second set of functions further comprises receiving a fax and receiving a voicemail at the mobile device and saving the fax and saving the voicemail as health records.
